(19) United States
(12) Patent Application Publication
(10) Pub. No.: US 2025/0153572 A1
(43) Pub. Date: May 15, 2025

(54) SYSTEM AND METHOD FOR RESPONDING TO ISOLATION FAULT

(71) Applicant: GILLIG LLC, LIVERMORE, CA (US)

(72) Inventors: Steven J. Dunbar, Livermore, CA (US); Binh Nguyen, San Lorenzo, CA (US)

(21) Appl. No.: 18/913,637

(22) Filed: Oct. 11, 2024

Related U.S. Application Data
(60) Provisional application No. 63/665,185, filed on Jun. 27, 2024.
(60) Provisional application No. 63/548,007, filed on Nov. 10, 2023.

(51) Int. Cl. B60L 3/04; B60K 35/21; B60K 35/26; B60L 3/00; B60L 50/60; G07C 5/00; G07C 5/08; H01M 10/42

(52) U.S. Cl. CPC B60L 3/04; B60L 3/0046; B60L 3/0069; B60L 50/60; G07C 5/008; G07C 5/0825; G07C 5/0833; H01M 10/425; B60K 35/21; B60K 35/26; B60K 2360/178; H01M 2010/4271; H01M 2010/4278; H01M 2220/20

(57) ABSTRACT

In a method and apparatus for use with an electric vehicle in an inactive state, when a signal from a battery management system indicates that a battery pack has an electrical isolation fault, a signal is transmitted through a transmitter that includes information corresponding to the existence of the fault.

### PRIORITY CLAIM

This application claims the benefit of U.S. Provisional Application No. 63/665,185, filed Jun. 27, 2024, entitled “System and Method for Responding to Isolation Fault,” and U.S. Provisional Application No. 63/548,007, filed Nov. 10, 2023, entitled “Electric Vehicle Battery Maintenance Systems and Methods.” The foregoing applications are hereby relied upon and incorporated by reference herein in their entireties for all purposes.

### TECHNICAL FIELD

Embodiments of the present disclosure generally relate to the field of high-voltage electrical systems. Certain embodiments of the present disclosure may find use in electrically powered vehicles, among other applications.

### BACKGROUND

High-voltage electrical systems are found in a variety of applications, including in electrically powered vehicles. In general, a high-voltage electrical system may include a power source, such as one or more batteries, that provide electrical power to an electrical load. As an example, a battery powered electric bus might have a plurality of high-voltage battery packs or individual high-voltage batteries in arrangements other than packs (any of such arrangements may be referred to as energy storage systems, or ESSs) that serve as the power source for a variety of high-voltage components or systems on the bus, such as an electric drivetrain, a heating, ventilation, and air conditioning (HVAC) system, an air compressor, a coolant heater, and DC/AC inverters. These high-voltage systems may operate at voltages up to seven hundred fifty volts direct current (750 VDC). Other high-voltage electrical systems have other components that operate at similarly high, or higher, voltages. Electric vehicles may also carry low-voltage batteries (sometimes referred to as “house” batteries) to power the vehicle's controllers and low-voltage electrical components, such as headlights, cabin lights, entertainment components, gauges, and starter motors. In addition to providing power to the electric vehicle's powertrain, the high-voltage battery packs charge the house batteries while the vehicle is in operation.

As should be understood, high-voltage battery packs are designed for operation within a band of temperatures (of the battery cells themselves), for example, not lower than −20° C. and not higher than 55° C. The particular upper and lower temperature boundaries depend on the battery chemistry and design and are provided by the battery manufacturer to a vehicle original equipment manufacturer. Damage to the high-voltage batteries may occur if the battery temperature exceeds the manufacturer-designated high temperature or falls below the manufacturer-designated low temperature. While the electric vehicle is in operation, the high-voltage loads draw electric current from the high-voltage battery packs during all or almost all of the operational period. As should be understood, the draw of current from the batteries, and the recharging of those batteries, e.g., through regenerative braking or from a shore power connection when the vehicle is at a charging station, generates heat in the battery packs. As a result, the high-voltage batteries tend to be warm during vehicle operation, even if ambient temperatures are low. It is known for vehicles to employ battery cooling systems that circulate coolant in a closed loop that flows through and between cooling plates proximate the battery packs so that the battery packs transfer heat to the coolant in the plates and thereby to a heat exchanger within the vehicle's closed-loop heating-ventilation-air-conditioning (HVAC) refrigerant system, at which the battery coolant contributes heat to the HVAC refrigerant in a heat exchanger located functionally in the refrigerant loop's evaporator portion. Such cooling systems may operate continuously while the vehicle is operating, or may operate in response to detection of a high-voltage battery temperature over the battery manufacturer's high temperature limit.

As should be understood, high-voltage battery manufacturers may include temperature sensors in certain, but not all, of the cells within the battery pack. These sensors output signals indicative of the cells' temperature to a controller (a battery management unit, or BMU) packaged within the battery pack that manages the pack's operation. The BMU, in turn, outputs a signal to the vehicle's vehicle control unit (“VCU”) through a powertrain control unit, directly or through a battery management system controller (“master BMS”). The master BMS, which is used when a vehicle has more than one battery pack, is external to the battery pack and is connected to all battery packs to communicate therewith. The master BMS communicates with all BMUs, has access to the status of all packs, and has control over all packs. While the vehicle is in operation, each BMU is responsible to report its pack status, which includes battery cell temperatures as described above, to the master BMS. The master BMS is programmed with manufacturer-provided high and low temperatures that it uses to determine when to send to the thermal management system (“TMS”) a heating or cooling request (with the corresponding target temperature). The TMS then operates a heating or cooling system, as the case may be, to provide heating or cooling to the battery packs to maintain them at the target temperature while the vehicle is in operation.

Too-cold conditions of the high-voltage batteries tend to occur when the electric vehicle is inactive. In such periods, the vehicle is in a state in which the vehicle's high-voltage battery loads do not draw electric current from the high-voltage batteries, either because the high-voltage batteries are disconnected from their loads, e.g. because the high-voltage battery pack contactors are open, or because, whether or not the high-voltage batteries are electrically connected to one or more of their loads, those loads are deactivated so that they do not draw current from the batteries. The latter condition may occur, e.g., because a computer system that controls the high-voltage loads actively maintains the loads in an inactive state or because the controllers of the computer system enter a low-power, or sleep, mode in which the controllers cease their system operative functions. Unless the battery packs are connected to a shore power source for recharging, the battery pack temperatures may tend toward temperatures ambient to the vehicle, and in cold ambient conditions, when the vehicle is inactive for a sufficiently long time, high-voltage battery temperatures may move below the battery manufacturer's rated low temperature. To keep the high-voltage batteries above the low temperature threshold while the vehicle is in operation, it is known to include resistive heating elements in the vehicle, either proximate the high-voltage batteries so that the heating elements' actuation directly transfers heat to the battery packs or proximate the closed path of coolant in a system as described above, in which a pump circulates the hot coolant through plates proximate the high-voltage batteries. In such arrangements, the heater contributes heat to the battery coolant, which in turn contributes heat to the battery packs when the coolant flows through the plates proximate the packs.

A battery management system may also monitor the pack for occurrence of isolation faults during the vehicle's operation. An isolation fault is a breach of the battery pack's electrical isolation. For example, a leak of battery coolant that contacts both a battery pack terminal and the vehicle frame may cause a short circuit to ground, whereas the coolant's contact with both pack terminals could create a short between those terminals of a magnitude that could create a risk of thermal runaway. It is known for the battery management system to monitor electric current in the battery pack against a voltage and resistance that are expected based on the battery pack's construction. If the current is lower than expected, the battery management system determines the resistance (between high voltage positive or high voltage negative, to chassis ground) that would need to be in parallel with the known resistance in order to result in the presently measured current. The calculated resistance, when divided by the known voltage and thereby described in units of ohms per volt (Ω/V), describes the degree of the isolation fault. The calculation's magnitude varies inversely with the magnitude of the current leak, in that the lower the calculated parallel resistance, the greater the electric current, which corresponds to current leaking from the battery pack, that would flow through that calculated parallel resistance in the model circuit. Under the SAE J2910 standard, an isolation fault is defined in an alternating current system at 500 Ω/V or lower and in a direct current system at 100 Ω/V or lower. If the battery management system detects an isolation fault, the battery management system outputs a reporting signal to the vehicle controller, which triggers a fault warning alarm light on the driver's instrument cluster, warning the driver to stop the vehicle.

The foregoing discussion is intended only to illustrate various aspects of the related art in the field of the disclosure at the time and should not be taken as a disavowal of claim scope.

### SUMMARY

An electric vehicle according to one or more embodiments in accordance with the present disclosure includes a body supported by a plurality of wheels, at least one electric motor disposed so that the at least one electric motor drives the plurality of wheels, a high-voltage electric storage power source in selective electrical communication with the at least one electric motor and having a temperature, and a low-voltage electric storage power source having a state of charge and being in selective electrical communication with the high-voltage electric storage power source via a switch that is controllable to a closed state in which the switch conveys electric power from the high-voltage electric storage power source to the low-voltage electric storage power source. A temperature control system is in operative communication with the high-voltage electric storage power source so that actuation of the temperature control system causes an exchange of heat between the temperature control system and the high-voltage electric storage power source. A computer system is in operative communication with the switch, the temperature control system, the high-voltage electric storage power source, and the low-voltage electric storage power source, and is configured to execute program instructions when the electric vehicle is in an inactive state, so that upon detection that the temperature of the high-voltage electric storage power source is outside a predetermined range, the computer system actuates the temperature control system, and upon detection that the state of charge of the low-voltage electric storage power source is below a predetermined level, the computer system controls the switch to its said closed state.

In another embodiment, an electric vehicle includes a body supported by a plurality of wheels, at least one electric motor disposed so that the at least one electric motor drives the plurality of wheels, a high-voltage electric storage power source in selective electrical communication with the at least one electric motor, and a low-voltage electric storage power source in selective electrical communication with the high-voltage electric storage power source via a switch that is controllable to a closed state in which the switch conveys electric power from the high-voltage electric storage power source to the low-voltage electric storage power source. A temperature control system is in operative communication with the high-voltage electric storage power source so that actuation of the temperature control system causes an exchange of heat between the temperature control system and the high-voltage electric storage power source. A computer system is in operative communication with the switch, the temperature control system, the high-voltage electric storage power source, and the low-voltage electric storage power source, and that is configured to execute program instructions, so that, in a low-power mode in which the computer system deactivates the temperature control system and opens the switch, the computer system monitors temperature of the high-voltage electric storage power source and, upon detection that the temperature of the high-voltage electric storage power source is outside a predetermined range, actuates the temperature control system, and monitors a state of charge of the low-voltage electric storage power source and, upon detection that the state of charge of the low-voltage electric storage power source is below a predetermined level, controls the switch to its said closed state.

In a further embodiment, an electric vehicle includes a body supported by a plurality of wheels, at least one electric motor disposed so that the at least one electric motor drives the plurality of wheels, and a transmitter. At least one battery pack is in selective electrical communication with the at least one electric motor. A battery management system is configured to output a first signal that includes information identifying whether the at least one battery pack has an electrical isolation fault. A computer system is in operative communication with the battery management system and the transmitter and is configured to execute program instructions when the electric vehicle is in an inactive state, so that, upon detection that the first signal indicates that the at least one battery pack has an electrical isolation fault, the computer system transmits a second signal to a remote party through the transmitter that includes information corresponding to the existence of the electrical isolation fault indicated by the first signal.

In a still further embodiment, a method of managing operation of an electric vehicle includes providing a body supported by a plurality of wheels, at least one electric motor disposed so that the at least one electric motor drives the plurality of wheels, a high-voltage electric storage power source in selective electrical communication with the at least one electric motor, a low-voltage electric storage power source in selective electrical communication with the high-voltage electric storage power source, and a temperature control system in operative communication with the high-voltage electric storage power source so that actuation of the temperature control system causes an exchange of heat between the temperature control system and the high-voltage electric storage power source. While the temperature control system is deactivated and the high-voltage electric storage power source is electrically disconnected from the low-voltage electric storage power source, a temperature of the high-voltage electric storage power source, and a state of charge of the low-voltage electric storage power source, is monitored. The temperature control system is actuated in response to the temperature of the high-voltage electric storage power being outside a predetermined range. Electric power is provided to the low-voltage electric storage power source from the high-voltage electric storage power source in response to the state of charge being below a predetermined level.

In another embodiment, a method of managing operation of an electric vehicle includes providing a body supported by a plurality of wheels, at least one electric motor disposed so that the at least one electric motor drives the plurality of wheels, a high-voltage electric storage power source in selective electrical communication with the at least one electric motor, a low-voltage electric storage power source in selective electrical communication with the high-voltage electric storage power source, and a temperature control system in operative communication with the high-voltage electric storage power source so that actuation of the temperature control system causes an exchange of heat between the temperature control system and the high-voltage electric storage power source. While the electric vehicle is in an inactive state, a temperature of the high-voltage electric storage power source, and a state of charge of the low-voltage electric storage power source, is monitored. The temperature control system is actuated in response to the temperature of the high-voltage electric storage power being outside a predetermined range. Electric power is provided to the low-voltage electric storage power source from the high-voltage electric storage power source in response to the state of charge being below a predetermined level.

In another embodiment, a method of managing operation of an electric vehicle includes providing a body supported by a plurality of wheels, at least one electric motor disposed so that the at least one electric motor drives the plurality of wheels, at least one battery pack in selective electrical communication with the at least one electric motor, a battery management system configured to output a first signal that includes information identifying whether the at least one battery pack has an electrical isolation fault, and a transmitter. While the electric vehicle is in an inactive state, upon detection that the first signal indicates that the at least one battery pack has an electrical isolation fault, a second signal is transmitted to a remote party through the transmitter that includes information corresponding to the existence of the electrical isolation fault indicated by the first signal.

In a further embodiment, a method of managing operation of an electric vehicle includes providing a body supported by a plurality of wheels, at least one electric motor disposed so that the at least one electric motor drives the plurality of wheels, at least one battery pack in selective electrical communication with the at least one electric motor, and a battery management system configured to output a first signal that includes information identifying whether the at least one battery pack has an electrical isolation fault. While the electric vehicle is in an inactive state, the battery management system is deactivated and intermittently activated to monitor the first signal. Upon detection that the first signal indicates that the at least one battery pack has an electrical isolation fault, the electric vehicle exits the inactive state.

### BRIEF DESCRIPTION OF THE DRAWINGS

Having thus described some example embodiments in general terms, reference will now be made to the accompanying drawings, which are not necessarily drawn to scale, and wherein:

FIG. 1 is a schematic illustration of a circuit diagram of a high-voltage electrical system;

FIG. 2 is a perspective view of one example of an electrically-powered vehicle with which embodiments of the present disclosure may be used;

FIG. 3 is a schematic diagram of one example of a high-voltage and accessory architecture of an electrically-powered vehicle with which embodiments of the present disclosure may be used;

FIG. 4 is a schematic illustration of a circuit diagram of a high-voltage electrical system;

FIG. 5 is a schematic illustration of refrigerant and coolant systems that may be used with the high-voltage and accessory architecture of FIG. 3 within an electrically-powered vehicle as in FIG. 2;

FIG. 6 is a partial schematic illustration of the thermal management system as illustrated in FIG. 5;

FIG. 7 is a communication flow diagram illustration of a battery operation maintenance method according to one or more embodiments of the present disclosure, for use with the refrigerant and coolant systems as in FIG. 5 and the electrical architecture of FIG. 3;

FIG. 8 is a schematic illustration of a high-voltage battery pack and a corresponding temperature management heat exchanger, for use with the refrigerant and coolant systems as in FIG. 5; and

FIG. 9 is a schematic illustration of a circuit used in determining occurrence of an isolation fault.

Repeat use of reference characters in the present specification and drawings is intended to represent same or analogous features or elements of embodiments of the present invention.

### DETAILED DESCRIPTION

Reference will now be made in detail to present embodiments of the disclosure, one or more examples of which are illustrated in the accompanying drawings. Each example is provided by way of explanation of the disclosure, not limitation of the disclosure. In fact, it will be apparent to those skilled in the art that modifications and variations can be made in the present disclosure without departing from the scope or spirit thereof. For instance, any number of features illustrated or described as part of one embodiment may be used on another embodiment, in any combination, to yield a still further embodiment. Thus, it is intended that the present disclosure covers such modifications and variations as come within the scope of the appended claims and their equivalents.

Further, either of the terms “or” and “one of A and B,” as used in this disclosure and the appended claims is intended to mean an inclusive “or” rather than an exclusive “or.” That is, unless specified otherwise, or clear from the context, either of the phrases “X employs A or B” and “X employs one of A and B” is intended to mean any of the natural inclusive permutations. That is, either phrase is satisfied by any of the following instances: X employs A; X employs B; or X employs both A and B, regardless whether the phrases “at least one of A or B” or “at least one of A and B” are otherwise utilized in the specification or claims. In addition, the articles “a” and “an” as used in this application and the appended claims should generally be construed to mean “one or more” unless specified otherwise or clear from the context to be directed to a singular form. Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” may include plural references, and the meaning of “in” may include “in” and “on.” The phrase “in one embodiment,” or the like, as used herein does not necessarily refer to the same embodiment, although it may.

Embodiments of the present disclosure comprise apparatus, systems, and methods for maintaining operative conditions of high-voltage and low-voltage batteries in a high-voltage electrical system. In certain embodiments, the high-voltage and low-voltage electrical systems are components of an electrically powered vehicle, including but not limited to a passenger bus, and the electric stored power source includes one or more battery packs.

Although some embodiments are discussed below in the context of a battery electric bus, those of skill in the art will appreciate that the present disclosure is not so limited. In particular, it is contemplated that embodiments of the present disclosure may be used with any suitable high-voltage electrical system, including high-voltage electrical systems in vehicles, buildings, power plants and grids, marine applications, and solar applications, among other applications. Electrically powered vehicles with which embodiments of the present disclosure may be used include, but are not limited to, battery electric and/or gasoline- or diesel-electric hybrid cars, trucks, and buses, electric motor/fuel cell vehicles, or any other vehicle having electrical systems where high-voltages are present.

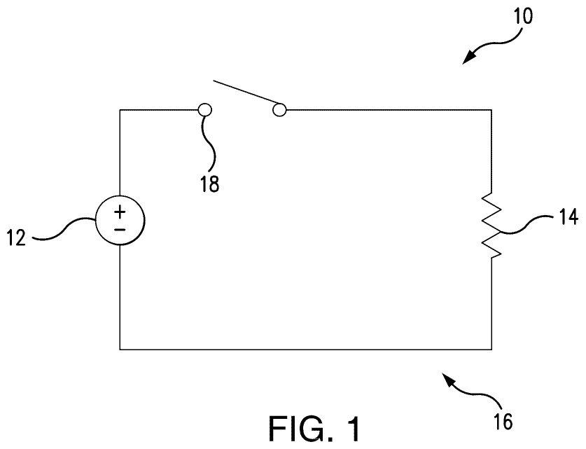

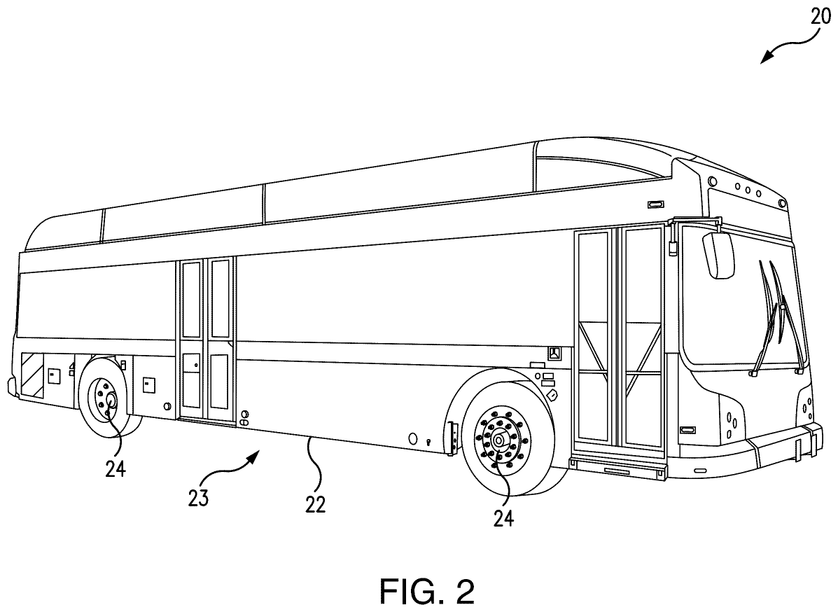

In this regard, FIG. 1 presents a schematic circuit diagram of a high-voltage electrical system in which one or more embodiments of the present disclosure may be effected. A high-voltage electrical system 10 includes an electric storage power source 12 and an electrical load 14. In various embodiments, electric storage power source 12 is a high-voltage storage power source, such as a vehicle battery pack, operative to supply power at high voltages to electrical load 14. As should be understood, a battery pack is a collection of battery cells, organized into a plurality of modules. Each module is comprised of multiple battery cells connected in parallel, series, or both. Each pack includes a controller, referred to herein as a battery management unit (BMU), that monitors the total voltage across the pack, from the electrical input to the electrical output, current into and out of the pack, and the state of health of the cells. Each pack may have a plurality of temperature sensors, each sensor packaged within a respective cell within the pack and outputting a respective signal to the BMU. Typically, the system does not include a temperature sensor for each cell but, rather, for a sufficient number of cells, in various spaced apart locations within the pack, so that the signals from the temperature sensors are representative of the temperature of the cells across the battery pack. The BMU averages the temperatures from the temperature sensors and averages the measured temperatures to achieve a battery pack temperature. In the embodiment shown in FIG. 2, power source 12 (FIG. 1) is a high-voltage power source that may be, e.g., within a range of about 500 volts direct current (VDC) to about 1000 VDC and, in some embodiments from about 750 VDC to about 900 VDC, used, e.g. in an electric vehicle such as a bus, that is electrically isolated from vehicle systems other than those incorporated in the vehicle's high-voltage system.

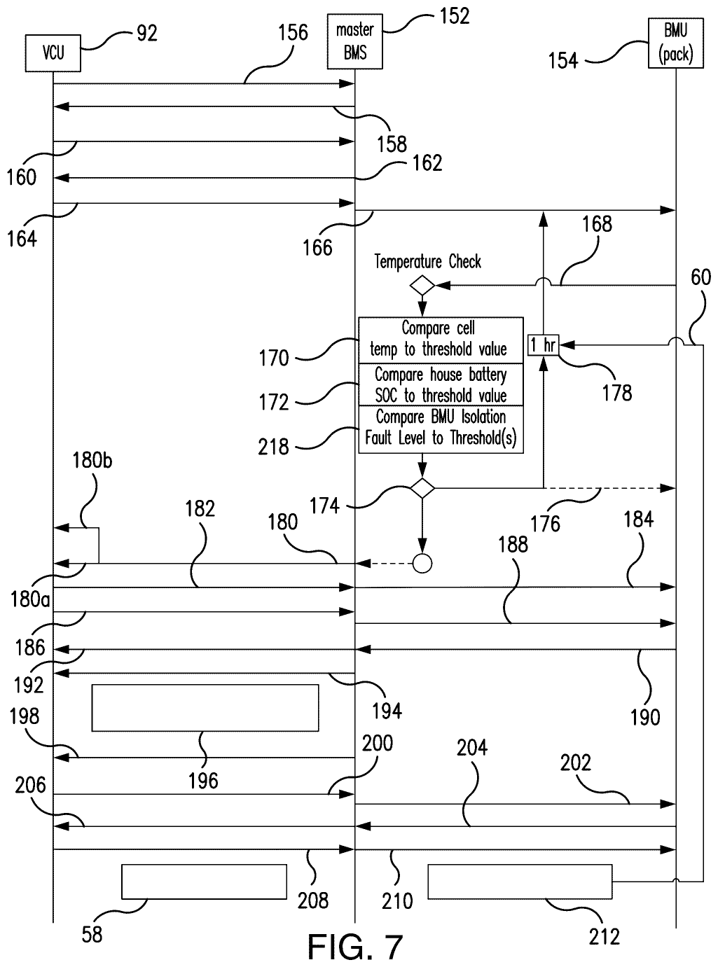

In one or more embodiments, the BMU (see, e.g., 154, FIG. 7) also monitors its battery pack for occurrence of isolation faults. Referring to FIG. 9, when the battery contactor for the BMU's battery pack is open, the BMU monitors an electric current 100 in the battery pack through a resistance 110 (R) in a circuit with a voltage 108 (V), where V and R are expected values based on the battery pack's construction. If the current is lower than expected, the BMU determines a resistance 112 that would need to be in parallel with known resistance 110 in order to result in presently-measured current 100 through known resistance 110. Calculated resistance 112, when divided by the BMU by known electric potential 108, and thereby described in units of ohms per volt (Ω/V), describes the degree of the isolation fault. The BMU then compares the calculated value, in Ω/V, against a first threshold of 500 Ω/V. If the calculated value is at or below this level, but above 100 Ω/V, the BMU categorizes the fault to be a non-critical fault. If the calculated value is at or below 100 Ω/V, the BMU categorizes the fault as being a critical fault. The BMU outputs a signal on the CAN bus to the master BMS that includes (i) information indicating that an isolation fault exists, (ii) if so, information indicating the fault's status, e.g. whether the fault is non-critical or critical based on the thresholds above, and (iii) information identifying the calculated value, in Ω/V.

Still referring to FIG. 1, the term “high voltage,” as used herein, refers to electrical energy at voltage drops across individual components or groups of components of the electrical load above approximately fifty volts alternating current (50 VAC) or fifty volts DC (50 VDC). In the illustrated example, high-voltage electrical system 10 includes electrical circuitry 16 that provides electrical communication between, and includes, electric power source 12 and electrical load 14. Thereby, electric power source 12 applies high-voltage power to electrical load 14.

Also as shown in FIG. 1, a switch 18 is disposed in electrical circuitry 16 upstream from electrical load 14 with respect to electric power source 12. As used herein, the term “switch,” with regard to electrical circuits, refers to a device that operatively exists in at least two states, one of which opens flow of electric current in at least a part of the electrical circuitry, and one of which conducts such flow. The switch, e.g., a lever-operated switch or an electrical contactor, may be self-contained in a housing, such that the actuator, e.g., mechanical force applied by an operator to a switch handle or electromagnetic force from a relay, changes the switch's state without removal of components from the housing. Thus, it will be understood that the switch may comprise various current disconnect devices operated, e.g., by any of various electrical, mechanical, magnetic, electromechanical, or electromagnetic components and arrangements. Accordingly, in high-voltage electrical system 10 switch 18, in a first (e.g., closed) state, conducts electric current within electrical circuitry 16 through switch 18. In a second (e.g., open) state, switch 18 opens at least part of electrical circuitry 16 so that the high-voltage power is not applied to at least part of electrical load 14. Although a single switch 18 is shown in FIG. 1, those of skill in the art will appreciate that high-voltage electrical system 10 comprises at least one switch 18 and, in some embodiments, will comprise a plurality of switches 18.

FIG. 2 is a perspective view of one example of an electrically powered vehicle 20 with which embodiments of the present disclosure may be used. In this example, vehicle 20 may be a passenger or transit bus, though as noted above embodiments of the present disclosure may be used with many other types of electrically powered vehicles. It will be appreciated that vehicle 20 comprises a body 22 supported by a wheeled chassis 23 in a body-on-frame construction. However, the present disclosure is not so limited, and in some embodiments vehicle 20 may have a unibody or monocoque chassis construction. As described in more detail below, vehicle 20 also comprises a propulsion system comprising at least one electric motor that is also supported by the wheeled chassis and that may comprise individually dedicated motors for the respective wheels. The at least one electric motor drives wheels 24 on axles of the wheeled chassis. Additionally, and also as described below, vehicle 20 comprises a stored electric power source supported by the wheeled chassis and in electrical communication with the propulsion system. In various embodiments, the electric stored power source comprises one or more battery packs. Examples of battery packs may be analogous to the lithium ion battery packs offered by various manufacturers, including Cummins Inc. of Columbus, Indiana and BorgWarner Akasol AG of Darmstadt, Germany. In one particular embodiment, vehicle 20 is a battery electric bus that is entirely electrically powered. In other embodiments, vehicle 20 may be a hybrid power bus employing an engine-generator in communication with one or more suitable battery packs.

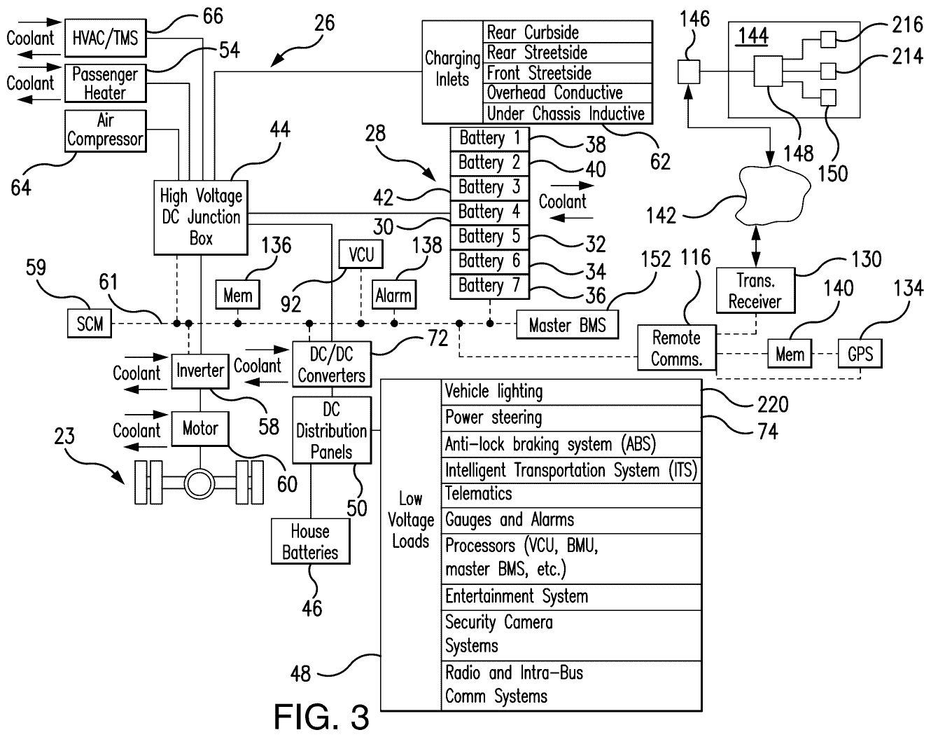

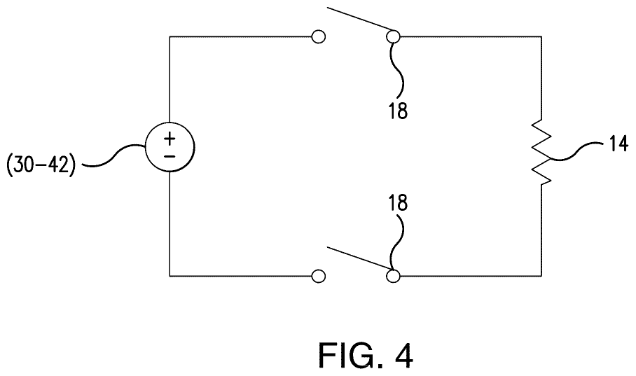

Referring also to FIG. 3, a schematic diagram is presented of one example of a high-voltage and accessory architecture 26 of an electrically powered vehicle with which embodiments of the present disclosure may be used. In particular, architecture 26 comprises the high-voltage and low-voltage components and other electronic accessories of a battery-electric bus (indicated in FIG. 3 by chassis 23), and this architecture may be used in the electrically powered vehicle 20 of FIG. 2. As shown, architecture 26 comprises an energy storage system 28 that includes a plurality of battery packs, and in this illustrated embodiment seven such battery packs 30, 32, 34, 36, 38, 40, and 42 are provided. Battery packs 30-42 may be, e.g., BP74E Li-ion 74 kWh battery packs offered by Cummins Inc., 9 AKM 150 CYC 98 kWh battery packs offered by BorgWarner Akasol AG, or other suitable battery systems. Battery packs 30-42 may be disposed in a variety of locations on the electric bus, and all possibilities are intended to be within the spirit and scope of the present disclosure. In one example, battery packs 30-36 may be disposed on a roof of the battery-electric bus, battery packs 38 and 40 may be disposed in a powertrain compartment of the bus, and battery pack 42 may be disposed beneath a rear raised portion of the vehicle floor of the wheeled chassis. In one embodiment, each of battery packs 30-42 comprise two switches 18, e.g., electrical contactors, inside each battery pack, one for the positive high-voltage output and one for the negative high-voltage output, as shown at FIG. 4. As will be appreciated, both such contactors must be closed to complete the circuit for high voltage to be available outside of the battery pack.

Battery packs 30-42 are all in electronic communication (e.g., by high-voltage cables) with a high-voltage DC junction box 44. Junction box 44 receives positive and negative electrical connections from respective terminals of each battery pack 30-42. Junction box 44 comprises, in one or more embodiments, a single bus bar that joins the positive potential from all seven battery packs 30-42 and one bus bar that joins the negative potential of all seven packs 30-42. The bus bar (positive and negative) splits into respective outputs for the various systems described herein, e.g., for one or more bus compartment heaters, HVAC system components, air compressor, one or more electric traction motors, one or more DC/DC converters, etc. Thus, the non-battery components of architecture 26 are in electrical communication with energy storage system 28 via direct or indirect connections to high-voltage junction box 44. Such components, which may be viewed as an electrical load, are electrically disposed in parallel with respect to high-voltage junction box 44 and with respect to energy storage system 28.

A low-voltage (or “house”) battery system 46 is mounted to the bus chassis, e.g., in one or more embodiments, in a compartment forward of the left front wheel well, but in other embodiments mounted at other positions on the chassis. Battery 46 may be, e.g., one or more 24 VDC batteries that drive so-called house loads 48, such as head lights, cabin lights, dash warning lights (such as discussed below), gauges, power steering, anti-lock brakes, controllers, two-way radio and intra-vehicle communications systems, a surveillance camera system, and entertainment electronics, through a low-voltage junction box 50 when electric power is not provided by the high-voltage batteries through one or more DC/DC converters 72. Low-voltage junction box 50 distributes 24 VDC to various low-voltage systems. When power is not provided to junction box 50 from the high-voltage batteries and DC/DC converters, house batteries 46 supply the bus's low-voltage loads. When the high-voltage battery contactors are closed and those batteries supply power to the bus systems, the low-voltage power from the high-voltage sources and DC/DC converters, and from the house batteries, form parallel low-voltage power sources. When the house batteries are low, they, therefore, become an additional low-voltage load for the high-voltage batteries and DC/DC converters as the high-voltage batteries and converters provide low-voltage power to the house batteries to recharge them. Where the bus is a hybrid-style bus, having both electric and internal combustion drivetrains, a second low-voltage battery may be provided to drive a starter motor for the internal combustion engine in a parallel hybrid arrangement, though it should be understood that a series hybrid bus may have no starter motor.

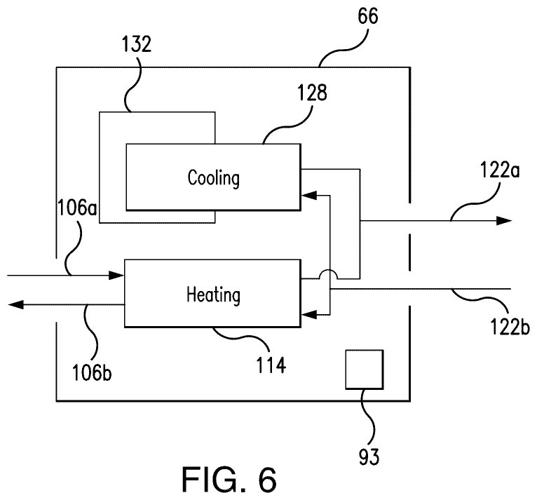

The bus system includes, relevant to the present disclosure, five types of controllers-a powertrain control unit (PCU) 59, a vehicle control unit (VCU) 92, a thermal management system (TMS) controller 93 (FIG. 6), a master battery management system controller (master BMS) 152, and a battery management unit (BMU) 154 (FIG. 7), and a remote communications controller 116, the operation of each of which is discussed herein. Controllers are also present within and control the operations of a transmitter/receiver 130 and a global positioning system (GPS) unit 134. This group of controllers, because, in one or more embodiments, they control actuation and operation of the temperature control system comprised of heater 54, pump 88, TMS 66 (described below) and related components that selectively provide heating or cooling to the high-voltage batteries, because they control closing and opening of the switches (e.g., the battery pack contactors) that selectively apply charging power from the high-voltage battery packs to the low-voltage house batteries, and because they detect and control responses to isolation faults, may be considered in the discussion of one or more embodiments herein a computer system. Other controllers relevant to operating the temperature control system or connecting and disconnecting charging power from the high-voltage battery packs to or from the low-voltage house batteries may be considered part of the computer system, but also may not be. Similarly, one or more of the VCU, the PCU, the TMS controller, the master BMS, the BMUs, the remote communication controller, the transmitter/receiver controller, and the GPS controller may be excluded from consideration as part of the computer system, e.g. where the temperature control system may be maintained in an inoperative state and the switch may be maintained open without reliance on such one or more controllers or where one or more of the functions of monitoring for temperature conditions, low charge conditions, or isolation faults is omitted. In one or more embodiments, the BMUs and master BMS may be considered part of a battery management system, with the VCU and other controllers being part of a vehicle computer system that interacts with the battery management system. VCU 92 and master BMS 152, VCU 92 and TMS controller 93, master BMS 152 and TMS controller 93, VCU 92 and PCU 59, VCU 92 and remote communications controller 116, remote communications controller 116 and transmitter/receiver 130, and GPS unit controller 134 communicate with each other over a Control Area Network (CAN) bus, indicated in dashed line at FIG. 3 at 61. It should also be understood that controller 116, transmitter/receiver 130, memory 140, GPS controller, and associated antenna may be combined in a packaged device, which connects with the CAN bus only at controller 116 but which can effect the functions as discussed herein with regard to those components. Thus, it should be understood that the discussion regarding the components of FIG. 3 encompasses either arrangement or other suitable arrangements. VCU 92 is the general controller that controls the vehicle's electrical, and some mechanical, functions, as should be understood. TMS controller 93 may be considered part of VCU 92, and it should be understood that certain functions attributed to VCU 92 herein may be performed by TMS controller 93. Each high-voltage battery pack 30, 32, 34, 36, 38, 40, and 42 is packaged with a respective controller (the battery pack's BMU 154) that monitors a plurality of temperature sensors disposed respectively in certain, but not all, battery cells in the pack, that controls the opening and closing of contactors between the battery cells and high-voltage junction box 44, that controls valves in the pack to try to maintain the battery pack's temperature within its rated operative temperature band, and that monitors the battery pack for the existence of isolation faults. Master BMS 152 communicates with the individual BMUs 154 (FIG. 7) in each respective battery pack 30-42 over CAN bus 61 for managing operation of the overall high-voltage battery pack collective and interfacing with the VCU.

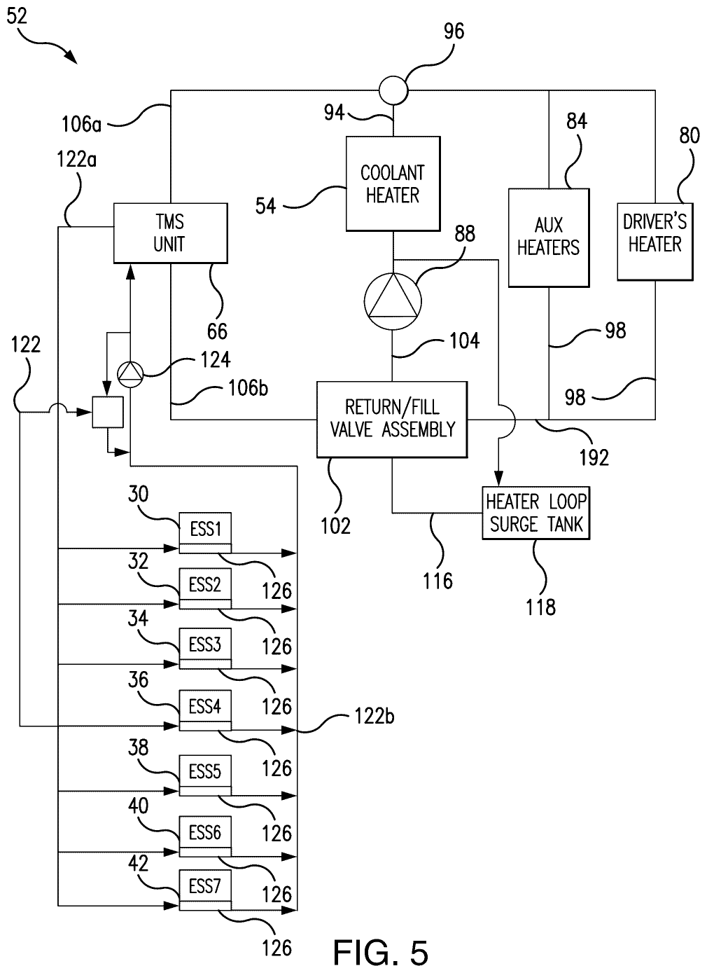

Architecture 26 comprises an active thermal management system (“TMS”) 66 in electrical communication with junction box 44. TMS 66 includes heating and cooling systems and components thereof that are driven by high-voltage power, such as a coolant heater, one or more heat exchangers, and one or more HVAC system components, notably a refrigerant compressor. Although, in FIG. 5, coolant heater 54 is illustrated as being separate from TMS 66, it should be understood that this is for purposes of illustration only and that the coolant heater 54, a pump 88, and corresponding fluid valves and lines can be considered part of the TMS.

Certain other high-voltage components of architecture 26 are in electrical communication with junction box 44, for example, a motor inverter 58 that receives the high-voltage DC current from junction box 44, converts the direct current from junction box 44 to alternating current, and outputs the AC current to an AC traction motor 60 (or multiple electric motors) that drives the wheels of the bus. Additionally, a plurality of charging systems 62 are in electrical communication with HVDC junction box 44. One or more, e.g., three, of these systems may be DC plug-in inlets at which a DC shore source is plugged to input DC shore power to junction box 44. Similarly, overhead conductive charging rails may be provided that make conductive contact with an overhead DC power bus, as should be understood in this art. An inductive charging pad or pads may be provided underneath the bus to take advantage of inductive charging systems sometimes provided on municipal routes. When shore power is provided at any of charging systems 62 (at a time when the bus is inactive, in that the high-voltage loads, such as electric motor propulsion and the bus's coolant and heating systems, are not drawing electric current from the high-voltage batteries), the resulting high-voltage current flow to junction box 44 provides high-voltage DC power to batteries 30-42 (thereby charging the batteries), to TMS 66, to one or more passenger heaters 54, to an air compressor 64, and low-voltage power (via DC/DC converters 72) to the low-voltage loads and to charge house battery 46. As the bus is typically inactive when connected to shore power, motor 60 is generally inactive when shore power is provided. As indicated, HVDC junction box 44 is in electrical communication with air compressor 64 and a heating, ventilation, and air conditioning (HVAC) system that is part of TMS 66. Each of air compressor 64 and a compressor of TMS 66 is driven by an AC motor and provided with a DC/AC inverter (not shown) driven by the DC power from HVDC junction box 44 so that the respective inverters provide AC power to these components. As noted, architecture 26 also comprises low-voltage direct current (LVDC) junction box 50 that receives low-voltage DC power, e.g., via electrical communication with one or more DC/DC converters 72. In this example, low-voltage DC power may comprise 24 VDC power (e.g., set to a 29.5 VDC maximum output) but, more generally, refers to electric potentials of 50 VDC or below. Various low-voltage components and/or loads may be in electrical communication with LVDC junction box 50, such as house batteries 46 (for charging the house batteries via junction box 50 or applying power from the house batteries to the house loads), an electro-hydraulic power (EHP) steering pump 74 or other house loads (indicated generally at 48), an electronic cooling package (ECP) cooling system (specifically, in one or more examples, blower fans that drive an air flow over one or more heat exchangers to cool coolant flowing therethrough that also flows to and cools inverter 58, motor 60, and DC/DC converters 72, as indicated in FIG. 3), and an HVAC low-voltage connection (not shown) for one or more blower fans that form part of the HVAC system of TMS 66.

Electrically powered vehicles such as those described above with respect to FIGS. 2 and 3 may typically include one or more switches that, when actuated to be placed in an open position, operate to open at least part of the vehicle's high-voltage electrical circuitry so that high-voltage power is not applied to at least part of the electrical load. Very generally, the vehicle's electrical system may comprise a low-voltage circuit that controls one or more switches (e.g., breakers, contactors, and disconnects) electrically disposed within the vehicle's high-voltage circuitry to connect and disconnect the high-voltage battery packs to and from their electrical load in the vehicle. These switches are indicated generally at 18 in FIGS. 1 and 4. As discussed above, respective such switches, e.g., electrically controlled contactors, may be disposed in each battery pack control system, so that control of those contactors to a closed position applies high-voltage power to system 26 as discussed herein and control of those switches to an open position disconnects the packs from system 26. Alternatively, one or more of the switches can be disposed between the battery packs (rather than within the battery pack control system) so that actuation of a single switch (FIG. 1) or one or both of a pair of switches (FIG. 4) simultaneously controls application of power from the battery packs to the battery loads.

A telematics system may be used to facilitate communications with and the acquisition of data from various devices mounted at various locations about the electric vehicle. Thus, for example, VCU 92 additionally communicates via bus 61 with a memory 136, remote communications component processor 138, audible alarm 114, transmitter/receiver 130, GPS navigation unit 134, and a memory 140. Remote communications controller 116 controls the operation of transmitter/receiver (including one or more antennas) 130, GPS navigation unit 134, and memory 140, and related circuitry in support of these components, as will be understood in view of the present disclosure. As should be understood, transmitter/receiver 130 may comprise a cellular chipset and wireless modem in communication with remote communications controller 116. Remote communications controller 116 may also control the operation of transmitter/receiver 130 to receive signals from and transmit signals through the one or more antennas in communication with a wireless network 142. Upon receipt of information from signals received from the wireless network, remote communications controller 116 transmits such information in signals to VCU 92 via bus 61. Upon receipt of a transmission instruction from VCU 92 via the bus, remote communications controller 116 may drive transmitter 130 to transmit a signal, via the one or more antennas, carrying information provided by VCU 92 with the instruction, over the wireless network. Integrally with such operations, remote communications controller 116 may utilize memory 140 for data storage and as a source for computer program instructions upon which the controller operates. As should be understood, VCU 92 may operate similarly with regard to memory 136.

The cellular chipset may comprise or be a part of a cellular telephone, e.g. an analog or digital phone. The telephone circuitry may have the capability of switching frequency and may be capable of switching between analog (e.g. AMPS-advanced mobile phone service) and digital (e.g. TDMA-time division multiple access, CDMA-code division multiple access, or GSM-global system for mobile telecommunications) standards.

Wireless network 142 may be a computerized system that effects wireless data connections between network nodes. Network 142 may comprise a cellular network comprising cell towers, base stations, and mobile switching centers. The construction and operation of cellular communications networks, and other wireless communications networks, should be understood in this art.

In one or more embodiments, GPS navigation unit 134 is in communication with a GPS satellite constellation to receive GPS location signals broadcast therefrom and to acquire from the broadcast signals coordinates (e.g. global latitude and longitude) that identify the position of GPS navigation unit 134 and, as the navigation unit is mounted to the electric vehicle, electric vehicle 20. As should be understood, the GPS satellites within the constellation each includes an accurate time clock, such that the satellites transmit their location signals at predetermined instants. Navigation unit 134, which may include a satellite receiver, may be programmed to determine its latitude and longitude in response to differences in reception time of signals received from multiple (e.g. at least three) GPS satellites within the constellation. The navigation unit may have map data, e.g. stored in memory 140, defined in terms of global longitude and latitude and including at least an area local to the position of the electric vehicle. Upon deriving the unit's latitude and longitude coordinates, the navigation unit processor may retrieve a portion of the map data including and proximate the derived longitude and latitude and modify the map data to insert an indicator identifying the navigation unit's/electric vehicle's position in the map. Navigation unit 134 may provide the latitude and longitude coordinate data, the modified map data, and a time stamp, to remote communication controller 116 which, in turn, may transmit that information to VCU 92 via bus 61. VCU 92 may, in turn, transmit the information back to remote communications controller 116 for transmission to a fleet operator 144 via transmitter and receiver 130 and wireless network 142. Alternatively, upon receipt of a status request signal from remote fleet operator 144 via transmitter and receiver 130 over wireless network 142, VCU 92 may transmit an instruction to remote communications controller 116, instructing controller 116 to acquire GPS location and time data, as described above, and to transmit that data (which may include a modified map as described above) to the fleet operator via transmitter and receiver 130 and wireless network 142.

Electric vehicle architecture 26, in one or more embodiments, also includes an alarm 138 mounted, for example, on the electric vehicle's dash, such as at or in the vehicle gauge cluster. Alarm 138 may comprise, solely or in combination with other alarm components, circuitry that drives a blinking or constant amber light emitting diode (LED) or other light, depending on the state of a signal provided from VCU 92 to alarm circuitry 138 over CAN bus 61. Thus, to the extent alarm 138 includes a visual lighting device, the alarm may be considered part of the vehicle light system discussed herein that is powered by the vehicle's low power source. VCU 92 may, in turn, provide the control signal to alarm circuitry 138 in response to a signal placed on CAN bus 61 by master BMS 152 upon detection of a fault condition, such as an isolation fault as discussed herein. Alarm 138 may also include, or solely comprise, an audible component in the form of a horn or other audible annunciator that is also powered by the vehicle's low power source.

Fleet operator 144 is remote from electric vehicle 20 and its electronic accessory architecture 26 but communicates with the system of accessory architecture 26 over wireless network 142 via transmitter and receiver 130 and a fleet operator transmitter and receiver 146. Fleet operator 144 may operate one or more computer systems, each comprising a controller 148, memory 150, a display 214, and a keypad 216.

Accordingly, as discussed herein, information may be exchanged between fleet operator 144 and the electric vehicle and its accessory architecture 26. The vehicle accessory architecture, including its computerized operations and memory/data system, may be remote from the fleet operator, including from a dispatcher thereof. “Remote” does not necessarily refer to the physical relationships between the electric vehicle (and its accessory architecture) and the fleet operator's computer systems, but instead may indicate that neither computer system controls the operations or data of the other. Thus, the fleet operator may be remote from the electric vehicle and its accessory architecture, and vice versa, not necessarily indicating spatial separation (although the electric vehicle may often, if not always, be spatially separated from the fleet operator system), but instead indicating that one computer system does not have control over the other computer system, including its data. For example, in one or more embodiments, the fleet operator is located at the same facility as the electric vehicle, and remote communications controller 116 communicates with fleet operator 144 via a wired network 142.

FIGS. 5 and 6 illustrate a system 52 that heats and cools coolant used to control the temperature of battery packs 30-42 and that, in the illustrated embodiments, includes TMS 66 and passenger compartment coolant heater 54 (which, as noted, can be considered part of TMS 66). The one or more embodiments of the system illustrated by these Figures comprise three distinct coolant or refrigerant closed loop heat transfer subsystems, two relying on a water-based glycol coolant and one relying on an R-407C refrigerant. A coolant loop that cools traction motor(s) 60 (FIG. 3), DC/DC converters 72 (FIG. 3), and inverter 58 (FIG. 3) uses the same or similar coolant but is not part of system 52 and is not further discussed herein. As should be understood, a coolant is a liquid used in a closed loop heat transfer system, in which the coolant receives heat from a source at one part of the closed loop and transfers that heat to a heat exchanger at another point in the closed loop, that is configured to remain in a liquid phase through those heat transfers when operating within the heat transfer loop. A refrigerant is also used in a closed loop heat transfer system, in which the refrigerant receives heat from a source at one part of the closed loop and transfers that heat to a heat exchanger at another point in the closed loop, but the refrigerant is configured to change phase between liquid and gas at predetermined portions of the closed heat transfer loop, aided by pressure and temperature changes within the loop. Thus, both coolants and refrigerants may be described as cooling fluids.

Coolant heater 54 is the heat source in the first of the closed loop heat transfer subsystems—a cooling fluid loop with coolant that provides heat contributed to the coolant by heater 54 to bus cabin compartments through transfer of that heat to driver heater 80, located proximate the driver seat, and to a passenger heat exchanger (not shown), located in or proximate to the passenger seating portion of the bus's interior cabin area. One or more other heat exchangers may be provided in the closed loop, as indicated at 84, e.g., heaters placed under one or more seats in the bus passenger compartment. Coolant heater 54 receives coolant from a brushless variable speed motor pump 88 via a coolant hose disposed in fluid communication between the heater and the pump. Heater 54 can be any type of heater structure capable of contributing heat to the coolant, e.g., an electric resistance type heater rated at 20 kW output, a heater fueled by diesel fuel, or other heater capable of contributing heat to the coolant. Power to heater 54 and pump 88 is applied when BMUs 154 (FIG. 7) close their contactors in response to control signals from master BMS 152 (FIG. 3), controlled in turn by signals from VCU 92 (FIGS. 3 and 7), either directly or via PCU 59 (FIG. 3), thereby directing high-voltage power to the heater and the pump from battery packs 30-42 (FIG. 3) via high-voltage DC junction box 44 (FIG. 3). Thereafter, actuation of each of heater 54 and pump 88 occurs upon receipt of a control signal instructing the device to operate. The VCU, in response to its programming as discussed herein, may issue a control signal to heater 54 and/or pump 88, causing them to actuate. In other embodiments, the VCU sends the operating control signals to the PCU which, in turn, provides instructions to the heater and pump. These signals are carried, in these examples, by CAN bus 61 (FIG. 3).

From heater 54, coolant flows through a coolant hose 94 to a three-way T junction 96. A coolant pipe or hose branch 98 extends out of one output of junction 96 and splits, respectively leading to driver heat exchanger 80 and the one or more auxiliary heaters 84. Downstream of heat exchangers 80 and 84, coolant branch 98 reconverges and leads to a coolant junction/fill assembly 102. Junction 102 is an open junction that connects two incoming fluid paths with an output fluid path. It also includes manual valves used to input coolant into the fluid loop. Pump 88 draws coolant exiting from junction 102 via coolant hose section 104, completing the fluid loop through branch 98.

A coolant hose 106 extends out of a second output of junction 96, allowing coolant to flow from junction 96 to system 66. Part of coolant branch 106 extends into the housing of system 66. As described herein, thermal management system 66 may include a refrigeration system and is referred to herein as TMS 66. Referring also to FIG. 6, the input line of branch 106 (leading into TMS 66 in FIG. 5) is indicated at 106a, while the output line of branch 106 (returning coolant from TMS 66 to junction 102) is indicated at 106b. Coolant in input coolant line 106a can be directed to a heat exchanger 114. While heat exchanger 114 is provided, in this embodiment, within TMS 66, it will be understood that the heat exchanger may also be provided externally of that unit. TMS controller 93 (FIG. 6), in response to control signals from master BMS 152 or VCU 92 (FIGS. 5 and 7), controls the operation of valves to control the flow of coolant through lines 106 via relays (powered by 24 VDC from low-voltage junction box 50, FIG. 3) that control respective solenoids at the valves to open or close the valves. Coolant path 106 also directs the heated coolant through one or more passenger compartment heat exchangers. One or more fans move air over the passenger heat exchanger(s), removing heat from the heated coolant. The fan(s) move the now-heated air into the passenger compartment through vents in the passenger compartment wall.

The system illustrated in FIG. 5 also includes a surge tank 118 that collects overflow from the output of pump 88, returning the output to junction 102. A second surge tank is illustrated operatively about pump 124, discussed below.

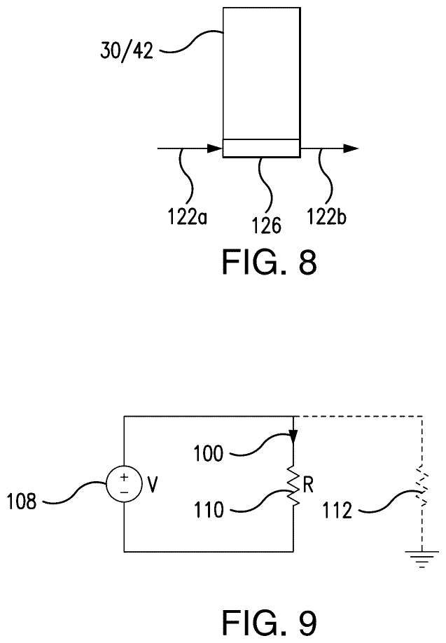

A second coolant fluid path 122, which is used to heat or cool, as the case may be, battery packs 30-42, is independent of the first coolant path in that both coolant paths are closed loops and the coolant paths do not have common portions, so that the coolant in those paths do not intermix with each other. Coolant path 122 includes a coolant hose through which a coolant, e.g., such as discussed above, flows under pressure provided by a low-voltage (e.g., 24 VDC) brushless DC variable motor pump 124. Path 122, though a closed loop, includes a plurality of parallel paths defined by plates 126 (FIG. 8), a respective one plate 126 being provided for each battery pack 30, 32, 34, 36, 38, 40, and 42 (FIG. 3). Each plate is made of a metal or other thermally conductive material. The coiled path extends through the plate so that the coolant flowing therethrough effectively transfers heat to or receives heat from the battery pack 30, 32, 34, 36, 38, 40, or 42, as the case may be, that sits upon the plate, as shown in FIG. 8. Referring to FIG. 8, coolant enters each plate 126 via an incoming portion of coolant pipe or hose 122, indicated at 122a, and exits the plate via an outgoing portion of coolant pipe or hose 122, as indicated at 122b. Referring again to FIGS. 5 and 6, pump 124 propels the coolant through closed loop coolant path 122, from heat exchanger 114 and evaporator 128 via the portion of coolant path 122 indicated at 122a to the seven ESSs 30-42 that are arranged in coolant path 122 in parallel with respect to each other, then up through pump 124 and back to heat exchanger 114 and evaporator 128 via the portion of coolant path 122 indicated at 122b. In the example discussed herein, pump 124 pumps coolant to all seven ESSs simultaneously. In other embodiments, a respective two-state (full flow or no flow) valve may be placed in the coolant path 122 immediately upstream of each ESS so that the valves are in parallel with each other at the respective inputs to the ESSs. In such embodiments, the master BMS controls each valve (via a relay through connection and disconnection of the valve's actuating solenoid to low-voltage junction box 50, FIG. 3) to allow coolant flow to the valve's associated ESS only when the VCU has determined that the given ESS needs coolant to heat or cool the ESS. The VCU controls all other such ESS valves to be closed. Returning to the present example, however, coolant flows to all seven ESSs, regardless whether all of the ESSs need heating or cooling. The relative positions of the ESSs in bus 20 (FIG. 2), e.g., whether the ESSs are above, below, or even with pump 124 and the length of the coolant path in the particular sub-loop in which a given ESS is disposed due to the distance between the ESS and pump 124, can define differences in pressures at the inputs and outputs of the ESSs in flow path 120, relative to each other. To equalize coolant pressure in closed-loop coolant path 120 at the ESSs, the coolant pressures at the ESSs can be modeled or measured in prototypes. Once pressure differences, if any, at the ESS entrances are established, coolant fluid pressure at the ESS entrances can be equalized by adjusting the coolant conduit diameter (via introduction of restriction or expansion couplings within the coolant lines or of short sections of conduit with differing diameters) immediately upstream of the ESSs. Pressure balancing in parallel fluid flow systems should be well understood and is not, therefore, discussed in further detail herein.

Heat exchanger 114 includes two coolant coil paths that are isolated from each other, one being part of the first coolant path (106, FIGS. 5 and 6), as discussed above, and the other being part of the second coolant path (122, FIGS. 5 and 6). The interleaving between the two coolant coil portions in heat exchanger 114 causes heat to transfer between the coolant flowing through the first coolant path's coil and the coolant flowing through the second coolant path's coil. Similarly, evaporator 128 includes a refrigerant path and a coolant coil path that are isolated from each other, the refrigerant coil being part of the refrigerant-based cooling fluid loop (132, FIG. 6) discussed below and the coolant coil being part of the second fluid loop (122, FIGS. 5 and 6). The interleaving between the refrigerant coil and the coolant coil in heat exchanger evaporator 128 causes heat to transfer between the coolant and the refrigerant.

The third cooling fluid loop is a refrigeration loop, indicated at 132 in FIG. 6, of a refrigeration system that is part of TMS 66 (FIG. 3) and that includes, in one or more embodiments, a compressor driven by power from high-voltage junction box 44 (FIG. 3). TMS controller 93 controls the compressor's operation. As discussed above, high-voltage power is applied to the compressor when the BMUs control their contactors to connect the high-voltage batteries to the high-voltage junction box. TMS controller 93 controls the compressor to actuate and deactivate via control signals provided to the compressor over the CAN bus, and also controls the operation of low-power valves to control delivery of conditioned air to the bus passenger cabin. A closed loop refrigerant path, e.g., primarily comprised of copper tubing, encloses a suitable refrigerant, such as R-407C. The compressor is disposed in the refrigerant path so that, when actuated, the compressor drives the refrigerant through the closed loop defined by the refrigerant path, raising both pressure and temperature of the refrigerant. A condenser coil is, in one or more embodiments, disposed in the TMS 66 housing downstream of the compressor within the refrigerant path (but, in one or more other embodiments is disposed outside the TMS housing, still downstream from the compressor and within the refrigerant path) so that the condenser coil receives compressed refrigerant from the compressor. The condenser coil is air cooled by one or more fans, which may also be disposed in or remote from the TMS 66 housing, depending on the condenser's disposition, that draw air from outside of the refrigeration system housing (and from outside the vehicle and into the TMS housing interior, if the fans are so disposed) and then over the condenser coil and back to ambient. Passing over the condenser coil, the air flow removes energy (heat) from the refrigerant flowing through the condenser, assuring that the refrigerant flow transitions to a liquid state. From the condenser coil, the compressor drives the refrigerant in path 132 to an expansion valve disposed at an inlet to the main evaporator coil and through which the refrigerant passes into the main evaporator coil, which is disposed in or adjacent to the bus's passenger cabin and, then, back to the compressor to thereby start the cycle through the refrigerant path again. As referenced herein, an expansion valve receives a fluid refrigerant input at a high pressure and, depending on the settings within the valve, outputs mixed liquid and gaseous refrigerant at a lower pressure and temperature. The refrigerant then enters the evaporator coil, where it absorbs heat to change phase into a gas. One or more second fans draw air into the interior of TMS 66 housing through vents between the bus passenger compartment and the TMS 66 housing interior (so that the second fan(s) draw air from the passenger compartment into the TMS housing interior), to the evaporator coil, and from the evaporator coil to a second set of vents in the TMS 66 housing, in which respective second fans are disposed, that opens into the passenger compartment. Ducting that may be provided from the vents to the evaporator coil, and that encloses the evaporator coil, is sealed so that the evaporator air flow is isolated from the interior of the TMS housing. As will be understood, the evaporator coil removes heat from the air flow as it flows over the coil, contributing heat to the refrigerant in the coil. The now-cooled air flow then circulates within the passenger compartment interior volume, lowering the passenger compartment's temperature.

TMS 66 includes a bypass refrigerant path for integration with the battery temperature control system described above. The TMS controller (FIGS. 3 and 7) controls (via a relay that connects and disconnects the valve's actuating solenoid to low-voltage junction box 50, FIG. 3) an expansion valve that is disposed in refrigerant path 132 to divert refrigerant in the refrigerant path to evaporator 128. An expansion valve receives the fluid refrigerant input at a high pressure and, depending on the settings within the valve, outputs mixed liquid and gaseous refrigerant at a lower pressure and temperature. The refrigeration coil fluid path in evaporator 128 is interleaved with the second coil fluid path in evaporator 128 (through which coolant flows as part of battery coolant flow path 122, as discussed above) to maximize surface area contact between the two coils, and such that, as a result, the battery system coolant flowing through the second coil path in evaporator 128 as part of coolant flow path 122 transfers heat to the gaseous refrigerant in the refrigerant coil path as the refrigerant and battery coolant each flows through its respective flow path. The refrigerant flows from evaporator 128, such that the refrigerant flow path from the refrigerant valve, to and through evaporator 128, and back to the compressor can be considered a part of refrigerant loop 132. The now-cooled battery coolant flows out of evaporator 128 and then to the respective ESS plates and pump 124, as discussed above.

Referring to FIGS. 3, 5, and 6, the TMS operates in either a heating mode or a cooling mode with respect to each of the passenger compartment and the battery coolant system and can provide heated or cooled conditioned air to the bus passenger cabin or can exchange heat with the battery coolant loop to control battery temperature up or down. For example, if the bus operator determines that the bus passenger cabin should be heated, the operator actuates a control to activate the TMS in passenger compartment heating mode to provide heated air to the passenger cabin and enters into the bus's user interface electronics a target temperature for the passenger compartment. The VCU receives these instructions and correspondingly sends an instruction signal to the TMS controller to operate in passenger compartment heating mode and conveying the temperature set point. The TMS controller initiates the passenger cabin HVAC fan(s) to move air in the cabin, thereby equalizing temperature throughout the cabin, and sends an instruction signal to VCU 92, which responsively actuates pump 88 to begin coolant flow through the first (heating) cooling fluid loop (including 106). After a period of time, the TMS controller begins checking the passenger cabin interior temperature as reported by one or more temperature sensors in the cabin, repeatedly comparing actual cabin temperature to the set point as it does. If the actual cabin temperature is, or if it later falls, below the set point, the TMS controller notifies the VCU. Because, in this example, the bus operator has actuated the heater, VCU 92, upon confirming that pump 88 is in operation, sends a signal to coolant heater 54, thereby actuating that component and beginning to heat the coolant in loop 106. The TMS controller opens valves to allow coolant in the first (heating) loop of coolant loop portion 106 to flow to the passenger cabin heat exchanger (not shown). The one or more fans that move air over the passenger heat exchanger and into the bus passenger cabin remain active, thereby heating the passenger compartment. The TMS controller repeatedly compares the existing passenger compartment temperature to the set point. When the passenger cabin's temperature reaches or exceeds (by a predetermined amount) the set point temperature, and if there is otherwise not a call from the master BMS controller to provide heat to the batteries, the TMS controller disables coolant flow to the passenger heat exchanger (not shown), though keeping active the passenger compartment fan(s) that move air over that heat exchanger and into the passenger compartment. The TMS controller notifies the VCU, which deactivates heater 54 if there is not otherwise a call from the master BMS controller for heat for the batteries. The VCU maintains pump 88 active for a period of time following deactivation of heater 54 to aid in the heater's cool-down. If the cabin temperature again falls below the set point temperature, the TMS controller re-actuates coolant flow to the passenger heat exchanger and notifies the VCU, which sends actuation signals to pump 88 and heater 54, as described above, to initiate actuation if those components are not already operating. If there is a call from the master BMS controller (to the TMS controller) to heat the batteries when the TMS is in passenger heating mode, the TMS controller opens a valve (not shown in FIG. 6) upstream from heat exchanger 114 to also direct the heated coolant in loop 106 to heat exchanger 114. The master BMS controller also conveys this signal to the VCU, which actuates pump 124 so that battery coolant in loop 122 also flows to heat exchanger 114 to acquire heat from the heated coolant in the first cooling fluid loop and heat the batteries therewith, as discussed above.

This cycle continues until the VCU receives a signal from the bus operator to discontinue passenger compartment heating, triggering the VCU to disable heater 54 and, after a period of time, pump 88, if there is no battery heating call from the master BMS and to notify the TMS controller. In turn, the TMS controller disables coolant flow to the passenger heat exchanger and disables the passenger compartment fan(s). If, instead, there exists a call from the master BMS controller to provide heat to the batteries, the VCU maintains pump 88 and heater 54 operational, though TMS controller 93 still disables coolant flow to the passenger heat exchanger and disables the passenger compartment fan(s), and the TMS controller maintains open the valve upstream from heat exchanger 114 so that the first cooling fluid loop is active through heat exchanger 114. The VCU actuates (or maintains active) pump 124 so that battery coolant also flows to heat exchanger 114 to thereby heat the battery loop coolant, as described above.

If, when the TMS is in passenger compartment heating mode, there exists a call from the master BMS controller to the TMS controller to cool the batteries, the TMS controller actuates the refrigeration system to move refrigerant through the third cooling fluid loop (except maintaining the expansion valve to the main evaporator closed), opens the expansion valve to evaporator 128, and closes the valve in the first cooling fluid loop portion 106 upstream from heat exchanger 114. The master BMS controller also sends the signal to the VCU, which actuates (or maintains active) pump 124 so that battery coolant also flows to evaporator 128. When the VCU receives an instruction from the driver interface to exit passenger compartment heating mode, the VCU disables heater 54 and, after a period of time, pump 88, and notifies the TMS controller. In turn, the TMS controller disables coolant flow to the passenger heat exchanger and disables the passenger compartment fan(s). If the master BMS controller has issued a call to cool the batteries when the driver deactivates passenger compartment heating mode, the TMS controller maintains the refrigeration system active (except for maintaining closed the expansion valve to the main evaporator) and maintains the expansion valve to evaporator 128 open, and the VCU maintains pump 124 active.

If the bus operator determines that the bus passenger cabin should be cooled, the operator actuates a control to activate the TMS in cooling mode and enters a corresponding target temperature. Upon receiving this information, VCU 92 sends an instruction to the TMS controller to operate its passenger compartment cooling mode and conveying the set point. The VCU does not actuate pump 88 or heater 54. The TMS controller initiates the passenger compartment fan(s), as described above, and checks the actual passenger cabin temperature from the one or more temperature sensors against the set point. If the actual temperature is above the set point, the TMS controller opens valves (including the expansion valve that allows refrigerant to flow to the main evaporator but not the bypass expansion valve to evaporator 128, although the TMS controller will maintain the bypass expansion valve open if it is already open due to a call from the master BMS controller to cool the battery packs, as discussed below) to allow refrigerant flow throughout the third (cooling) cooling fluid loop as described above and actuates the refrigeration system by actuating the refrigerant compressor and the one or more fans that move air over the passenger cabin evaporator and into the bus cabin. The TMS controller repeatedly compares the existing passenger compartment temperature to the set point. When the passenger cabin's temperature reaches or falls below (by a predetermined amount) the set point temperature, and if there is otherwise not a call from the master BMS controller to provide cooling to the batteries, the TMS controller disables the refrigerant loop system, though it maintains the passenger compartment fan(s) that move air over the main (passenger compartment) evaporator active. The TMS controller notifies the VCU of this condition. If the cabin temperature again rises above the set point temperature, the TMS controller re-actuates the refrigeration system. This cycle continues until the VCU receives a signal from the bus operator to discontinue passenger compartment cooling, triggering the VCU to notify the TMS controller. In turn, the TMS controller disables the refrigerant system.

If, when the system is in passenger compartment cooling mode, the master BMS provides the TMS controller an instruction to heat the batteries, the TMS controller maintains the bypass expansion valve to evaporator 128 closed, opens the valve upstream from heat exchanger 114 in the first (heating) cooling fluid loop, and closes the valve to the passenger compartment heat exchanger. The VCU, which also receives the signal from the master BMS controller, actuates pump 88 and, after confirming the pump's operation, coolant heater 54. The VCU also actuates pump 124. If, when the VCU receives a signal from the driver to discontinue passenger compartment cooling mode, there exists a call for battery heating, the VCU notifies the TMS to end passenger compartment cooling but maintain battery heating. The TMS controller deactivates the refrigeration system, including the expansion valve to evaporator 128 and the passenger compartment fan(s), opens (or maintains open) the valve upstream from heat exchanger 114 in the first (heating) cooling loop, and closes (or maintains closed) the valve to the passenger compartment heat exchanger. The VCU actuates (or maintains active) pump 88 and, after confirming the pump's operation, coolant heater 54. The VCU also actuates (or maintains active) pump 124. If, when the system is in passenger compartment cooling mode, the master BMS provides the TMS controller an instruction to cool the batteries, the TMS controller maintains the bypass expansion valve to evaporator 128 open. The VCU, which also receives the signal from the master BMS controller, does not actuate pump 88 or coolant heater 54 but does actuate pump 124. If, when the VCU receives a signal from the driver to discontinue passenger compartment cooling mode, there exists a call for battery cooling, the VCU notifies the TMS to end passenger compartment cooling but maintain battery cooling. The TMS controller maintains the refrigeration system active, including the expansion valve to evaporator 128, but closes the expansion valve to the main (passenger compartment) evaporator and deactivates the passenger compartment fan(s). The VCU also actuates (or maintains active) pump 124.

As noted herein, the master BMS controller monitors the BMUs, which report their battery pack temperatures to the TMS controller. If, while the electric bus is in an active state, any of these reports indicates that a battery pack temperature has fallen below a predetermined too-low threshold temperature (in one or more embodiments, approximately 18.5° C.), the master BMS controller sends an instruction to TMS controller 93 (or, in other embodiments, to VCU 92, which, in turn, provides an instruction to the TMS controller), instructing the TMS controller to actuate a battery heating mode and providing a battery temperature set point (in one or more embodiments, approximately 18.5° C.), and also provides a parallel instruction to the VCU. VCU 92, in response, sends a signal to pump 88 to actuate coolant flow in the first (heating) cooling fluid loop and, upon confirming the pump's operation, sends a signal to coolant heater 54, thereby actuating that component. The VCU also sends a signal to pump 124 to actuate, thereby actuating the second (battery) cooling fluid loop so that the first cooling fluid loop and the second cooling fluid loop can exchange heat at heat exchanger 114. The TMS controller opens valves to allow coolant in coolant branch 106 of the first (heating) loop to flow to heat exchanger 114 but does not open the valves to allow coolant in coolant branch 106 to flow to the passenger compartment heat exchanger and does not actuate the fan(s) that move air over the passenger heat exchanger and into the passenger cabin, although if the TMS is in passenger heating mode, as described above, when the master BMS notifies the TMS controller of the need for battery heating, the TMS controller does not discontinue passenger compartment heating and, thus, does not disable those devices. Similarly, if the TMS happens to be in passenger compartment cooling mode when the master BMS requests battery heating, the TMS controller maintains the components of the refrigeration system in an active state.

A lookup table stored in memory accessible to the TMS controller includes a series of temperatures, one for each incremental battery pack temperature over a predetermined range of battery pack temperatures that may be expected to be measured by the BMUs and reported to the master BMS in the particular vehicle in which the system and method of the present disclosure is used. The lookup table temperatures correspond to temperature of the coolant in battery cooling fluid loop 122 at a predetermined point in the loop, for example at or at a predetermined position upstream from the entrance to pump 124 (and downstream from battery packs 30-42), when each of battery packs 30-42 are at the predetermined temperature to which the lookup table temperature corresponds. The relationship between the lookup table temperatures and the battery pack temperatures will depend, as should be understood in view of the present disclosure, upon the battery pack characteristics, the characteristics of coolant loop 122 and its coolant, and the position in loop 122 at which coolant temperature is measured, and these relationships can be determined through modeling or testing. In other embodiments, the master BMS controller is programmed to output the set point in terms of coolant temperature rather than battery temperature, based on a similar understanding or testing of the relationship between battery temperature and coolant temperature in the particular vehicle system in use.

In operation of the battery heating mode, the TMS controller checks the temperature of the battery coolant in coolant loop 122 as reported by one or more temperature sensors in the coolant conduit at the entrance of, or immediately upstream of, pump 124 and downstream from the battery packs or, in one or more other embodiments, at a different point in coolant loop 122. If the measured battery coolant temperature is below the set point provided by the master BMS controller (as converted by the lookup table), the already-started operation of the battery heating process continues. The TMS controller repeatedly compares measured battery coolant temperature to the converted set point. While the battery coolant temperature remains below the converted set point from the lookup table, the TMS controller and the VCU maintain operation of coolant loop portion 106 and coolant loop 122. Heated coolant from coolant loop portion 106, and coolant from battery coolant loop 122, thus both enter heat exchanger 114. As described above, the battery coolant in coolant path 122 at heat exchanger 114 removes heat from the coolant in passenger compartment coolant path portion 106. In one or more embodiments, battery coolant also passes through refrigeration system evaporator 128, but if the refrigeration system is inactive or, if active but the TMS controller closes the expansion valve to evaporator 128 in that system as described above, heat exchanger 128 does not remove heat from the coolant in coolant path 122. The now-cooled heater coolant in branch 106 returns to coolant junction 102 via coolant path portion 106b. On the battery side, pump 124 moves the now-heated battery coolant from heat exchanger 114, and the unaffected coolant from heat exchanger 128, in TMS 66 to all of the ESS heat transfer plates 126, thereby transferring heat from the battery coolant in the plate to the battery cells sitting on the plate and warming the batteries, including the one or more batteries that is under the too-low temperature threshold.

In one or more embodiments, when the battery coolant (in coolant loop 122) temperature reaches or exceeds (by a predetermined amount) the converted set point temperature, the TMS controller notifies the VCU of this condition, and the VCU deactivates pump 124, thereby deactivating coolant loop 122. In one or more other embodiments, once the TMS controller determines, after receiving a battery heating request from the master BMS controller, that the battery coolant temperature is below the set point, the TMS controller maintains its battery heating mode until receiving an instruction from the master BMS controller to exit battery heating mode. The master BMS controller repeatedly monitors battery pack temperature, as discussed herein, and sends an instruction to deactivate battery heating mode when the lowest battery pack temperature (or, e.g., average battery pack temperature) reaches or exceeds (by a predetermined amount) the 18.5° C. threshold temperature. The master BMS controller similarly notifies the VCU of this condition, and the VCU deactivates pump 124, thereby deactivating coolant loop 122. In either type of embodiment, if the TMS is not otherwise in passenger compartment heating mode, of which, as discussed above, the VCU is aware, the VCU also deactivates pump 88, heater 54. If the TMS is in passenger compartment heating mode, the VCU maintains pump 88 and heater 54 in an active state, subject to operation of the passenger compartment heating mode. If the master BMS controller later detects that a battery pack temperature has fallen below the set point temperature, the master BMS controller again sends a request for battery heat, along with a set point, to the TMS controller and the VCU, thereby repeating the cycle.

If, while the electric bus is in an active state, any of the BMU battery pack temperature reports to the master BMS controller indicates that a battery pack temperature has risen above a predetermined too-high threshold temperature (in one or more embodiments, approximately 27.5° C.), the master BMS controller sends an instruction to TMS controller 93 (or, in other embodiments, to VCU 92, which, in turn, provides an instruction to the TMS controller), instructing the TMS controller to actuate a battery cooling mode and providing a battery temperature set point (in one or more embodiments, approximately 27.5° C.), and also provides a parallel instruction to the VCU. The VCU sends a signal to pump 124 to actuate, thereby actuating the second (battery) cooling fluid loop so that the third cooling fluid loop and the second cooling fluid loop can exchange heat at evaporator 128. The VCU does not, in response, actuate pump 88 or heater 54, though the VCU will maintain those components in operation (though closing the valve upstream from heat exchanger 114) if the TMS is in passenger compartment heating mode at the time the master BMS controller provides the battery cooling instruction. The TMS controller opens valves (including the bypass expansion valve that allows refrigerant to flow to evaporator 128) to allow refrigerant flow throughout the third (cooling) cooling fluid loop 132 as described above and actuates the refrigerant compressor. The TMS controller does not open the expansion valve to allow refrigerant in refrigerant loop 132 to flow to the passenger, or main, evaporator and does not actuate the fan(s) that move air over the main evaporator and into the passenger cabin, although if the TMS is in passenger cooling mode, as described above, when the master BMS notifies the TMS controller of the need for battery cooling, the TMS controller does not discontinue passenger compartment cooling and, thus, does not disable the passenger compartment fan(s) or close the expansion valve to the main evaporator.

In operation of the battery cooling mode when the vehicle is in an active state, the TMS controller repeatedly compares the existing battery coolant temperature to the converted set point temperature. While the battery coolant temperature remains above the converted set point from the lookup table, the TMS controller and the VCU maintain operation of cooling fluid loops 132 and 122. Refrigerant from refrigerant loop 132 and coolant from battery coolant loop 122, thus, both enter evaporator 128 (which may be considered a heat exchanger in this arrangement). As described above, the refrigerant in coolant path 132 at evaporator 128 removes heat from the coolant in battery coolant loop 122. In one or more embodiments, battery coolant also passes through heat exchanger 114, but if the passenger heating system is inactive, heat exchanger 114 does not contribute heat to the coolant in coolant path 122. If the passenger heating system is active, the valve immediately upstream from heat exchanger 114 is closed, as described above, and, again, heat exchanger 114 does not contribute heat to the coolant in a coolant path 122. Pump 124 moves the now-cooled battery coolant from evaporator 128, and the unaffected coolant from heat exchanger 114, to all of the ESS heat transfer plates 126, thereby cooling the plates and drawing heat from the battery cells sitting on the plates, including the one or more batteries that is above the too-high temperature threshold, and transferring that heat to the coolant in coolant loop 122. When the battery coolant's (in loop 122) temperature reaches or falls below (by a predetermined amount) the converted set point temperature (or, in other embodiments, when the TMS controller receives a signal from the master BMS controller that the highest battery pack temperature has sufficiently fallen below the 27.5° C. temperature monitored by the master BMS controller), the TMS controller closes the bypass expansion valve to evaporator 128. If the TMS is not otherwise in passenger compartment cooling mode, the TMS controller deactivates the compressor, thereby disabling the refrigerant loop system. The TMS controller notifies the VCU of this condition (or, in other embodiments, the master BMS controller notifies the VCU), and the VCU deactivates pump 124, thereby deactivating battery coolant loop 122. If the TMS is in passenger compartment cooling mode, the VCU maintains the compressor and evaporator fans in an active state, and the expansion valve to the main evaporator open, subject to operation of the passenger compartment cooling mode. If the master BMS controller later detects that a battery pack temperature has risen above the set point temperature, the master BMS controller again sends a request for battery cooling, along with a set point, to the TMS controller and the VCU, thereby repeating the cycle.

In one or more embodiments, when a high voltage battery pack contactor is closed, the battery pack's BMU does not monitor for isolation faults. Instead, a dedicated master isolation controller monitors the vehicle's entire electrical system for isolation faults and reports any such detected faults to the VCU, triggering the VCU to actuate a warning lamp or instrument cluster message to the vehicle operator instructing the operator to deactivate the vehicle.

The discussion above addresses how the vehicle's controller system operates the refrigerant and coolant systems while the electric vehicle is in operation, meaning that the electric vehicle's operational systems are in a normal power mode. In an inactive state of the vehicle, the vehicle's high-voltage loads do not draw electric current from the high-voltage batteries, e.g., the high-voltage battery packs. This condition may exist because the battery contactors are open, thereby electrically disconnecting the high-voltage batteries from the high-voltage loads, such as the electric motor(s) and the battery temperature control system, so that the high-voltage loads are inoperative for that reason or because, whether or not the high-voltage batteries and their loads are electrically connected, the vehicle controllers control the loads to be inactive such that they are inoperative, e.g., where they not draw electric current from the high-voltage batteries. In one or more embodiments, when the vehicle is in an active state, meaning that the vehicle's high-voltage batteries are electrically connected to the high-voltage loads and those loads are in an operative state, the vehicle's operational systems that control heating or cooling of the batteries that drive the vehicle's motor(s), and that monitor for the occurrence of isolation faults, are active. Thus, in examples as discussed herein, the one or more controllers that are necessary for control of such systems' operation are all in a normal power state. In one or more examples, the vehicle driver can control whether the vehicle is in an active or inactive state, and thus whether these heating or cooling, and/or isolation fault detection, operational system controller(s) are in the active or inactive states, through use of a key in the electric vehicle's ignition or through actuation of other controls in the vehicle cabin. The electric vehicle's actuation is typically a two-step process. Using a key in an ignition of an electric bus as in FIG. 2, for example and referring again to FIG. 3, the operator turns the key from its position in the vehicle's off condition through a first position that connects the house batteries' low-voltage power supply (24 VDC), to which the keyed switch is connected, to a hardwire connection to the vehicle's general controller, in this example VCU 92, making that input to the VCU (at 180a but not 180b, FIG. 7) go high. The VCU, in turn, provides ignition power (in this instance, the 24 VDC power it receives from the house batteries at its 180a, FIG. 7, input) (hereinafter, ignition power signal KL15) to various bus systems, including bus controllers PCU 59, master BMS 152, and TMS controller 93. Master BMS 152 connects ignition power to BMUs 154. The connection of ignition power to the bus controllers awakens the controllers out of a low power mode (discussed below) and thus triggers their operation and accessibility for communication. The VCU also provides low-voltage power to vehicle lights, gauges, and other house accessories.

Prior to receiving ignition power, the controllers may have been in a low power, or “sleep,” mode in which the controllers do not receive ignition power but are connected to a power source, in one or more examples the bus's 24 VDC low-voltage batteries (hereinafter, power signal KL30) at an input different from the input at which they receive ignition power. In the absence of ignition power, the KL30 power signal allows the controllers to perform a limited number of functions but without capability to perform the normal vehicle control functions the controllers perform when the controllers are in an active state, under ignition power. As noted above, in the illustrated embodiments, the low-voltage power supply can be considered the parallel output of (i) the high-voltage output from junction box 44 (FIG. 3), stepped down by DC/DC converters 72, and (ii) house batteries 46. At or prior to vehicle start-up, however, the contactors between the high-voltage battery packs and junction box 44 are open, so that the house batteries alone constitute the low-voltage supply.

Continuing to turn the key, the driver reaches the key's final position, at which the ignition system triggers a signal to VCU 92, causing the VCU to conduct a check of systems related to bus safety and to send a signal to PCU 59 to close the contactors between the high-voltage power source and the high-voltage junction box. In response to that signal, PCU 59 signals master BMS controller 152 to close the contactors, causing the master BMS controller to check the status of the battery packs and, if that check is clear, send respective signals to each battery pack's BMU 154 (FIG. 7), instructing the BMU to close the contactor in its battery pack. Closing the contactors, the BMUs thereby make available high-voltage power to the vehicle motor(s) and other operational systems, as discussed above. As high-voltage power is electrically connected to high-voltage loads, and the controllers that control operation of those high-voltage loads are operational in full-power mode, the vehicle is active, with respect to those high-voltage loads.

To turn the bus off, or put it in an inactive state, the operator can turn the key all the way back to its original, off, position. When the operator so keys off the bus, the ignition power input to the VCU goes low, triggering the VCU to disengage ignition power to many of the bus systems, including the bus controllers other than those that control certain functions that need always to be operative. In some instances, the VCU does this by directly disengaging ignition power to the controller, such as to the master BMS controller. In other instances, the VCU's control of one controller, such as the master BMS controller, causes that controller to, in turn, disengage ignition power to its subordinate controllers, such as the BMUs (causing the BMUs to automatically open their high-voltage battery contactors). The loss of ignition power causes the controller to enter into sleep mode, as described herein, the process of which may involve conducting system status or safety checks prior to fully disabling functional capability under the low power mode.

Instead of a key/ignition arrangement, vehicles may have a dual pushbutton or knob arrangement through which the driver actuates the vehicle in these two power-up steps and the power-down step.

When the bus is inactive, and the operational systems that control heating or cooling of the batteries and closing and opening of the battery pack contactors, e.g., the computer system controllers as discussed above, are inactive in low power mode, the high-voltage batteries may be susceptible to dropping below the batteries' rated minimum temperature. For example, and depending on a high-voltage battery's construction and chemistry, a high-voltage battery may become incapable of either discharging or being charged, at some point within a range of about-20° C. to about −40° C., while from about −5° C. to the point at which the battery can neither charge nor discharge, the battery can discharge but not charge. Similarly, without connection to the high-voltage batteries during the controllers' inactive condition, the house battery(ies) may be susceptible to falling below a minimum state of charge (e.g., at or about 40%) considered necessary for reliable operation.

In one or more embodiments of electric vehicle 20 (FIG. 2), and referring to FIGS. 3 and 7, the vehicle provides low-voltage power to vehicle controllers VCU 92, battery master system management controller 152, seven battery management units (BMUs) 154, and other controllers while the controllers are in sleep mode. Each controller can enter a sleep mode, in which the controller draws enough power from this 24 VDC source so that the controller remains in the state in which it existed when going into sleep mode, without need to reboot when later exiting sleep mode, and maintains a few certain fundamental functions, such as clocks. Otherwise, the controller shuts down its processing and communication functions so that the controller draws little power. Each controller can force itself into sleep mode under predetermined conditions or enter that state in response to an instruction from a controller in a superior position in the system architecture. For example, each controller has two power inputs, the 24 VDC low power input KL30 discussed above and the 24 VDC ignition power input KL15. When the ignition power input goes low, each controller forces itself to go into sleep mode (in one or more embodiments, the controller may perform a series of system safety checks before fully entering sleep mode but otherwise ceases its processing functions). If the ignition power input later goes high, the controller exits low power mode.

Not all controllers in the bus control system enter sleep mode. Certain controllers execute functions that need to be carried out regardless of the bus's activity. For example, the bus may include an equalizer controller (not shown) that constantly balances the house batteries between the bus's 12 VDC and 24 VDC systems. The equalizer controller also detects the house batteries' state of charge. The equalizer controller is in continuous communication with the CAN bus and responds over the CAN bus to queries from the master BMS controller for house battery state of charge information. The VCU does not disengage this controller from ignition power, even when the bus becomes inactive, thereby precluding the controller from entering a low-power mode.

It should be understood in view of the present disclosure that the constant application of 24 VDC to the controllers at the KL30 input can tend to deplete the house batteries over time. In the case of an electric bus, this is unlikely to be problematic because an in-service bus is likely to be driven daily and is, therefore, unlikely to be inactive for a time long enough to drain the house batteries due to this function. In one or more embodiments, however, the 24 VDC power input KL30 is applied to those controllers that would otherwise enter a low-power mode upon loss of ignition power via a user-operated switch so that, if the electric vehicle is to be unused for an extended period of time, particularly in circumstances in which battery over-cooling or over-heating is considered unlikely, the user can manually disconnect the KL30 power input through operation of the switch. With the switch opened, the KL30 low power input to those controllers is disabled, and the controllers are not in a low-power mode. When the operator closes the switch, the controllers boot up and enter operation. They may later enter sleep mode and execute the monitoring method as disclosed herein. The following discussion assumes that the KL30 power input is applied, whether automatically or by closure of such a switch.

In a still further embodiment, VCU 92 intermittently communicates with a weather forecasting source when not in low-power mode. If the forecast for a predetermined period of time in the future, e.g., two days, indicates that ambient temperatures will stay above the batteries' rated low temperature and below the batteries' rated high temperature, the system opens the KL30 power input switch to the controllers when the bus is keyed off, thereby disconnecting power to those controllers that would otherwise go into a low-power mode. If, however, the forecast predicts temperatures at or below the batteries' rated low-voltage level, or at or above the batteries' rated high temperature, the system maintains the KL30 power switch closed so that the controllers subject to sleep mode receive that power input when the controllers enter sleep mode, as discussed herein.

In one or more embodiments, a system and method as in the present disclosure monitors the temperature of the vehicle's high-voltage batteries, charge level of the vehicle's low-voltage batteries, and for the occurrence of isolation faults when the vehicle is inactive or otherwise when the vehicle's one or more controllers that control the vehicle's high-voltage battery thermal management system, low-voltage battery charging, and/or monitoring for occurrence of isolation faults, e.g. the controllers comprising the computer system as described above, are in an inactive state and, upon detecting a predefined condition for either battery type, changes those one or more controllers to an active state, thereby allowing the vehicle's systems to take action to address the detected condition. In one or more embodiments, once the electric vehicle's operator turns off the vehicle, in this example an electric bus, e.g., by keying the bus off and thereby causing the VCU's ignition power input to go low as discussed herein, the VCU, as part of the steps by which it enters into sleep mode (relying on power from the VCU's 24 VDC KL30 input), brings low the ignition power inputs to other controllers that are intended to enter low-power mode when the vehicle is inactive, including those controllers comprising the computer system as described above, causing those controllers to start entering low-power modes themselves and, possibly, causing one or more of them to disable ignition power to one or more controllers downstream from them. In this process, the VCU instructs the master BMS, which in one or more embodiments is part of the computer system as described above, to enter a monitoring mode (before or as it also enters its sleep mode). Under the monitoring mode, the master BMS intermittently, e.g., periodically, wakes up (exits sleep mode) and, in doing so, instructs the BMUs to wake up, without triggering any other controller in the bus to wake up. The other bus controllers in sleep modes, including the other controllers, if any, that are part of the computer system as described above, do not wake up at this point in the monitoring mode process, and do not wake up thereafter until the monitoring mode process causes ignition power to again be applied to those processors or until the driver keys on the bus. When the master BMS and the BMUs are out of their sleep modes, the BMUs determine respective temperatures of their battery packs and (the contactors for their respective battery packs being open) determine the magnitude of isolation fault, if any, in units of Ω/V, as described above, and the master BMS controller polls the BMUs for that information. The master BMS also queries the equalizer controller or other charge sensor at the house batteries to determine the house batteries' state of charge. As described above, each BMU automatically reports to the master BMS (via a message put on the CAN bus) any isolation fault the BMU detects at its battery pack, the message identifying the existence of a fault condition, whether the fault condition is critical or non-critical, and the magnitude of the fault, in Ω/V. In one or more embodiments, the master BMS controller also automatically puts a corresponding message on the CAN bus upon detecting an out-of-range temperature condition. Thus, in such embodiments, the master BMS does not actively poll the BMUs for fault information. Instead, the master BMS controller detects isolation fault and/or battery pack temperature information from the BMUs by receiving messaging therefrom over the CAN bus when the master BMS controller wakes up in monitoring mode.

If any high-voltage battery pack temperature is outside of a predetermined range (either too low or too high) or if the house battery state of charge is below a predetermined threshold, or if any of the BMUs detects an isolation fault of 500 Ω/V or less, the master BMS changes the state of the ignition power KL15 hardwire input to the VCU, thereby causing the VCU to exit its sleep mode and allowing the VCU to take corrective action. The master BMS ignition power signal is also directed, however, to an input to the VCU that is parallel to the ignition input to the VCU described above, thereby allowing the VCU to distinguish between receipt of ignition power at a bus key-on and receipt of a wake-up signal due to a condition arising from the monitoring mode. This allows the VCU, when reacting to the signals from the monitoring mode, to exit sleep mode and bring the other system controllers out of their sleep modes, as described above with regard to the ignition process, except that the VCU disables any propulsion commands from the bus throttle, or from any other source in the bus, and maintains the main or parking brake's engagement. If the basis during monitoring mode for the master BMS controller's awakening of the VCU is that any of the high voltage battery packs are outside their expected temperature range or because the house battery strength of charge has fallen below a predetermined threshold, the VCU causes the BMUs (through operation of the monitoring mode by the master BMS, as described below) to close the battery pack contactors, thereby charging the house batteries if needed, and actuates the TMS system, thereby allowing the TMS to mitigate out-of-range battery pack temperature if needed, as described above. Meanwhile, the master BMS continues to monitor the battery packs' temperatures and the house batteries' states of charge. When the temperature of all battery packs are within their predetermined acceptable operative range and the house batteries' state of charge are back up to a predetermined acceptable level, the master BMS changes the state of the hardwire signal to the VCU back low, causing the VCU to start its process back into sleep mode and to instruct the other controllers (by changing their ignition power input to low), including the master BMS, to do the same. The process repeats at the next intermittent wake-up of the master BMS controller and continues to repeat until an ignition wake up event, as discussed above, or a complete power shutdown. If the basis during monitoring mode for the master BMS controller's awakening of the VCU is the detection by any BMU of an isolation fault of a magnitude of 500 Ω/V or less, or 100 Ω/V or less, the VCU exits sleep mode, actuates visible (and/or, in some embodiments, audible) dash or instrument cluster alarm 138 (FIG. 3), and sends an instruction signal to remote communications controller 116 to send a report to fleet operator 144, reporting the isolation fault's existence, severity, and magnitude. Controller 116 then controls GPS controller 134 (FIG. 3) to provide information identifying the vehicle's location and controls transmitter/receiver 130 to transmit the isolation fault information and vehicle location information using fleet operator 144 via network 142. When the master BMS reports an isolation fault, the VCU does not instruct the master BMS to close the high voltage battery pack contactors, even if the master BMS has simultaneously detected an out-of-bounds battery pack temperature or a low strength of charge at the house batteries. Thus, the contactors remain open. Instead, having reported the isolation fault, the VCU maintains the alarm (and, in one or more embodiments, activates vehicle lighting) until, in one or more embodiments, expiration of a timer, e.g., five minutes, ten minutes, or twenty minutes, at which time the VCU disables monitoring mode and returns to sleep mode. By precluding battery pack contactor closure, the VCU may reduce risk of increasing a fault's magnitude. As a remedy, in the presently described embodiments, for detection of an out-of-range battery pack temperature or a low house battery state of charge is contactor closure, the VCU disables monitoring mode.

FIG. 7 provides a flow illustration of an example of this method, as executed by one or more examples of a system as described herein. Referring also to FIGS. 3, 5, and 6, when the bus operator keys on the bus, such as described above, VCU 92 initially sends an ignition power signal at 156 to master BMS 152, which may be considered an instruction to the master BMS to come to an active state, such that the master BMS exits sleep mode if it is in sleep mode. This assures that the master BMS is properly responding to the VCU's instructions. The communication at 156 is a hardwire communication between the VCU and the master BMS that applies to a predetermined input position on the master BMS. From the standpoint of the controller's programming, the controller responds to the hardwire signal as being a binary signal, existing in either of two states, 0V (low) or 24V (high), and the system controls these hardwire signals between those two states as discussed herein. Master BMS 152 interprets the low-to-high signal change at 156 as an instruction to exit its low power mode, causing the master BMS to reactivate its normal operating functions, or to maintain them active if the master BMS has not yet entered sleep mode, and thereby allowing the master BMS's applications to communicate with applications on other devices in the vehicle network system over a communications bus that operates according to the Controller Area Network (CAN) vehicle bus standard. Master BMS 152 sends a response message at 158 to VCU 92 over the CAN bus that the master BMS is active and communicating using the CAN protocol on the communications bus. The driver may operate the bus for some time but at some point keys off the bus, causing VCU 92 to bring the ignition power signal to the master BMS (and other controllers, e.g., those controllers that control heating and cooling of the high-voltage batteries and charging of the low-voltage batteries, as discussed herein) low (in this example, from 24 VDC to 0 VDC) at 164 (at the same input to the master BMS controller as at 156). This causes the master BMS to initiate its process of entering sleep mode, which includes making system and safety checks and discontinuing ignition power signals to the BMUs, causing the BMUs to enter sleep mode. At 160, however, just prior to disengaging the master BMS controller's ignition power, the VCU sends an instruction to the master BMS over the CAN bus to execute monitoring mode, as described herein. The master BMS returns a confirmation to the VCU over the CAN bus, at 162. The VCU maintains the monitoring mode signal at 160, in one or more embodiments, for as long as the vehicle remains in an inactive state or, in other embodiments, depending on other criteria as may be defined. The monitoring mode instruction causes the master BMS to actuate an application that resides at memory on, or at memory that is otherwise accessible by, the master BMS to execute the monitoring mode steps described herein. The master BMS executes monitoring mode for as long as the ignition power signal (156/164) to the master BMS is low and the master BMS does not receive an instruction at 160 to discontinue monitoring mode. Because the VCU has brought the ignition power signal low for all controllers that control high-voltage battery heating and cooling and low-voltage battery charging, the master BMS controller executes monitoring mode while those controllers are in their low-power mode.

The following discussion addresses, generally, the master BMS's subsequent actions as controlled by the monitoring mode application. The application's initiation causes the master BMS to initiate a one-hour clock countdown (see 178). Master BMS 152 exits its low power mode when the one-hour clock expires and, at 166, changes the hardwire ignition power (KL15) signal to each of the BMUs to 24 VDC. This causes each of the BMUs to exit their sleep modes and activate their respective battery packs, though not (yet) closing their battery back contactors. In response, each BMU sends a confirming CAN bus signal (not shown) to the master BMS and acquires signals from the temperature sensors at the cells within the BMU's battery pack and conducts an isolation fault test for its battery pack, as discussed above. Each BMU is programmed to identify, and does identify, the temperature that corresponds to each sensor output and to average the corresponding temperatures of the signals of all the sensors in its battery pack. In other embodiments, the BMU determines the highest and the lowest cell temperatures reported by its sensors. At 168, each BMU 154 responsively sends a message to master BMS 152 over the CAN bus identifying the BMU's average measured battery pack temperature (or highest/lowest temperatures). If the BMU has determined the presence of an isolation fault, the BMU message includes an identification of the presence of an isolation fault, the severity of that fault (e.g., based on the thresholds of 500 Ω/V and 100 Ω/V, as discussed above), and the magnitude of the isolation fault at its battery pack, in units of Ω/V. At 170, the master BMS compares the average temperature from the BMU with the two extreme (high/low) temperatures at either end of the battery pack's normal operative range, for example as defined by the battery manufacturer or as selected by the vehicle manufacturer, and provided in the master BMS's programming or reference data. In other embodiments, the master BMU compares the reported highest cell temperature with the predetermined high temperature threshold and compares the reported lowest cell temperature with the predetermined low temperature threshold, for each battery pack. At 172, the master BMS receives a signal from the equalizer controller that conveys the house batteries' state of charge (“SoC”) and compares that level with the predetermined SoC threshold, e.g., 40%, 50%, or other percentage. At 218, the master BMS controller compares, for each battery pack, the isolation fault level reported by the pack's BMU against two thresholds.

In one or more embodiments as discussed herein, the predetermined low temperature threshold in monitoring mode is a temperature approximately at or above the battery temperature at which the high-voltage battery can no longer accept a charge, though it may still discharge. As should be understood, this temperature range may vary by battery construction and chemistry, but in one or more embodiments is at or above approximately −5° C., and, e.g., is set in some such embodiments at about −5° C. In one or more other embodiments, the too-low threshold is set lower, e.g., about −20° C. or about −40° C., again depending on the battery, as the approximate temperature at which the battery neither discharges or accepts a charge. As reflected by the discussion above, the too-low threshold in monitoring mode while the vehicle is inactive, in such embodiments, is lower than the too-low threshold used when the electric vehicle is active, e.g., approximately 18.5° C., as described above. Similarly, the too-high threshold in monitoring mode while the vehicle is inactive is, in one or more embodiments, higher than the too-high temperature limit used when the vehicle is active (e.g., approximately 27.5° C.) and may be, e.g., the highest temperature at which the manufacturer rates the battery capable of use. Use of the narrower band between the too-low threshold and the too-high threshold in the vehicle's active operation tends to maintain the high-voltage battery temperature within a range corresponding to the batteries' most effective operation. Although use of the same (e.g., 18.5° C. and 27.5° C.) thresholds in monitoring mode/inactive operation and in the vehicle's active operation is in the scope of the present disclosure, use of a lower too-low threshold and a higher too-high threshold in the vehicle's inactive state is made in one or more other embodiments in which the objective is to maintain the high-voltage batteries in an operative or undamaged condition, even if not at peak effectiveness, while minimizing battery drain caused by activating vehicle systems out of the vehicle's inactive state.

In one or more embodiments, the isolation fault thresholds are 500 Ω/V and 100 Ω/V. It should be understood, however, that the thresholds for the existence of isolation faults and for critical isolation faults, respectively, can vary from these levels, as appropriate for the underlying system.

If, at 174, the reported temperature of all the high-voltage battery packs is within the BMU's rated range, and if the house battery's charge level is above the predetermined minimum, and if no battery pack has an isolation fault level at or below 500 Ω/V, then, at 176, the master BMS sends respective signals back to the BMUs for the BMUs to return to low power mode, in this example by again bringing low the ignition power signal to the BMUs. At 178, the master BMS restarts countdown of the one-hour clock and itself returns to low-power mode. Upon the next expiration of the one-hour clock, the master BMS returns to 166, instructing the BMUs to exit their low-power modes to conduct another check of battery cell temperatures and for isolation faults and checking the equalizer controller. As long as no high-voltage battery pack temperature moves out of range, and the house battery remains sufficiently charged, and no isolation fault measurement falls to or below the 500 Ω/V threshold, this loop of one-hour monitoring, with intervening low-power mode by the master BMS and BMUs, continues until the VCU disables the monitoring mode instruction at 160, until the Master BMS controller detects any error or fault in any high voltage battery pack or that the battery pack has dropped below 10% state of charge, all as reported by the pack's BMU, or until the VCU detects that the vehicle operator has initiated the vehicle's activation through a key/ignition activation or a push-button activation, at which point the VCU transitions the controllers' (including the master BMS controller's) ignition power signal to high (see 156), so that the master BMS controller ends monitoring mode and the controllers, generally, end their low-power modes and operate in their normal active modes, as discussed above, until the next vehicle deactivation causes VCU 92 to return the controllers to their low-power mode (see 164).

If, at 174, any one of the seven BMU average temperature measurements (or, if the BMU reports its lowest cell temperature, that lowest cell temperature) is below the rated low temperature for the battery packs, or if any one of the seven BMU average temperature measurements (or, if the BMU reports its highest cell temperature, that highest cell temperature) is above the rated high temperature for the battery packs, or if the house battery charge level is below the minimum threshold, or if the isolation fault level of any battery pack is below the predetermined isolation fault threshold, master BMS 152 sends a signal at 180 to VCU 92 (over a hardwire connection) to activate the controllers that control high-voltage battery heating/cooling, low-voltage battery charging, and isolation fault response. The signal at 180 is a hardwire signal that is controlled to be a binary signal, alternating between low (0V) and high (24 VDC). In this instance, the master BMS signals the VCU to activate vehicle controllers by changing hardwire signal 180 from low (0V) to high (24 VDC). Hardwire signal 180 is applied to two distinct VCU inputs. At 180a, the signal is applied to the same VCU input that also receives a hardwire signal corresponding to the vehicle's activation by key or pushbutton from the ignition system in the vehicle's driver console, as described above. The transition from low to high at 180a causes the VCU to change the state of a hardwire signal at 182 (this is the same signal as indicated at 156, i.e., ignition power KL15) to the system controllers, thereby causing those controllers to exit low power mode, as discussed above. This signal is applied to the master BMS (the same hardwire signal as at 156), thereby causing the master BMS to send a hardwire signal at 184 (i.e., the same hardwire signal as at 166) to the BMUs, which in turn causes master BMS and the BMUs to remain out of low-power mode. Additionally, if the VCU has not received a message from the master BMS that an isolation fault exists, VCU 92 instructs master BMS 152, over the CAN bus at 186, to close the contactors in each battery pack to thereby connect the high-voltage batteries to high-voltage junction box 44 (FIG. 3) and low-voltage junction box 50 (via high-voltage junction box 44 and step-down DC-to-DC converters 72, FIG. 3). If the master BMS has not received a message from any of its BMUs that an isolation fault exists, master BMS 152, at 188, sends messages to the BMUs over the CAN bus to close the contactors for their battery packs. Each BMU responsively controls the closing of the contactors at its corresponding battery pack and sends a response to the master BMS at 190 over the CAN bus that the contactors are closed. The master BMS reports this to the VCU with a CAN bus message, at 192.

Hardwire signal 180 is applied to a second input to the VCU, indicated at 180b, that does not receive a signal change when the vehicle operator actuates the vehicle by key or pushbutton. The change of state at 180b informs the VCU that the state change at signal 180a is not, in fact, from a vehicle driver but comes, instead, from the master BMS in response to a high-voltage battery pack temperature condition or an insufficient charge in the house battery or an isolation fault in the master BMS controller's execution of the monitoring mode. In response, the VCU actuates the vehicle's main brake system to a level sufficient to maintain the vehicle (e.g., the electric bus) in a stationary position and sends a signal to the PCU controller, which controls the vehicle's electric motor(s) in response to the driver's throttle input, instructing the PCU not to actuate the vehicle electric motor(s) in response to throttle input, thereby disabling propulsion from the bus's electric motor(s) to the bus wheels. The VCU also, in one or more embodiments, does not send ignition power to one or more systems in the bus that need not be active while the bus is inactive, such as lighting, and passenger compartment heating and air conditioning components such as air handling fans, thereby keeping those components in an inactive state and any controllers that operate them, but that are not involved in heating or cooling the batteries, in a low-power mode. This occurs regardless whether wake up is triggered by an out-of-range temperature condition, a low house battery state of charge, or an isolation fault.

Thus, in situations in which there is no isolation fault, with the high-voltage batteries on-line in the vehicle (albeit with the drivetrain locked), the vehicle may be considered in an active state but with propulsion to the wheels disabled through braking and throttle lock. Or, considered without regard to the vehicle as a whole, and including isolation fault conditions, the VCU has activated those controllers that control heating and cooling of the high-voltage batteries, charging of the low-voltage batteries, and monitoring for isolation faults. Now being in an active state, master BMS 152 repeatedly queries the BMUs for the high-voltage battery pack temperature and for isolation faults and the equalizer controller for the SoC of the low-voltage house battery(ies) at the loop 174-180-182-184-168-170-172-218-174.

Because, and assuming no isolation fault, high-voltage battery packs 30-42 now deliver low-voltage power to low-voltage junction box 50 (FIG. 3), the high-voltage battery packs are now re-charging the house battery(ies) 46 (FIG. 3). Thus, if the house battery charge level at 172 is the only condition that triggered the master BMS to instruct the VCU to activate the relevant vehicle controllers at 180a and 180b, no further action by the VCU is needed to address the triggering condition. If the batteries are not outside their high and low temperature thresholds, as discussed herein, the system continues to execute the 174-180-182-184-168-170-172-174 loop until determining that the house battery state of charge has risen above the too-low threshold, thereby triggering step 198 (discussed below) without triggering steps 194 and 196 (discussed below) or until a vehicle operator keys on the vehicle or entirely shuts down the power system or until a high-voltage error or fault occurs.

The master BMS knows, from the decision at 174, that its change of state of signal 180 was caused by one or more of the four possible triggering conditions (high-voltage battery temperature too high, high-voltage battery temperature too low, house battery charge state too low, and/or isolation fault). Regardless which one or more of those conditions caused the master BMS controller to trigger the relevant vehicle controllers' reactivation at 180, the master BMS maintains signal 180 in that state as long as any one of the four conditions exists. If, however, in repeatedly checking those conditions at the 174-172 loop, master BMS 152 detects that none of the four conditions exist (i.e., all high-voltage battery pack temperatures are above the rated low temperature, all high-voltage battery pack temperatures are below the rated high temperature, the house battery charge state is above the predetermined threshold, e.g., 40% or 50%, and there is no isolation fault), the master BMS, at 198, changes the state of the hardwire signal to the VCU (i.e. at 180a and 180b) that controls the VCU's activation of the vehicle controllers involved in the monitoring process. In response, at 200, VCU 92 sends an instruction over the CAN bus to master BMS 152 to open the high-voltage battery contactors, thereby ending house battery recharging and operation of the high-voltage components of the TMS. Master BMS 152 responsively sends instructions to the BMUs over the CAN bus at 202 to open the battery pack contactors. In response, the BMUs open the contactors and confirm this action to the master BMS via respective CAN bus messages at 204. Upon receiving such messages from all of the BMUs, master BMS 152 confirms to the VCU that the contactors have been opened, via a CAN bus message at 206. VCU 92 then, at 208, changes the state of the hardwire ignition power signal to master BMS 152 (i.e. the same hardwire signal as at 156/164/182) from high to low and does the same to the TMS controller, causing each of the master BMS controller and the TMS controller to initiate its low-power mode. Master BMS 152 correspondingly changes, at 210, the state of its hardwire connection to the BMUs that control the BMU's active/sleep state from high to low, causing the BMUs to return to a low power mode. Master BMS 152, at 212, returns to 178 to start the countdown of the one-hour clock, and transitions to low-power mode.

If the master BMS instructed the VCU to activate the relevant vehicle controllers at 180a and 180b either because, at 170, one or more of the high-voltage battery pack temperatures was above the too-high threshold or because one or more of the high-voltage battery pack temperatures was lower than the too-low threshold, then when master BMS 152 repeatedly queries the BMUs for the high-voltage battery pack temperature in the 174-218 loop after confirming closure of the battery pack contactors at 192, master BMS 152 continues to detect that triggering temperature condition until the condition changes. At 194, upon detecting the high temperature or low temperature out-of-range condition at 170, the master BMS sends a message to the VCU over the CAN bus, informing the VCU of the high-temperature or low-temperature condition. This message to the VCU, which the master BMS controller also sends directly to TMS controller 93 (FIG. 6), differentiates between the high-temperature and low-temperature conditions, so that the VCU and the TMS controller know whether battery cooling or battery heating is needed, and also includes a battery temperature set point. While battery pack temperatures can be different with respect to each other, they are generally sufficiently close that there would not be a too-high out-of-range condition simultaneously with a too-low out-of-range condition. In one or more embodiments, the battery temperature set point is the same (e.g. about 25° C.) in both instances and represents, in these examples, a temperature between the high and low thresholds within the temperature band within which the high-voltage batteries most effectively perform. The TMS controller converts this battery temperature set point to a battery coolant temperature set point through the lookup table, as discussed above. Master BMS controller 152 maintains the signal 160 upon the repeated detections of the condition that triggered its imposition.

As reflected herein, the system, in one or more examples, is configured to operate so that the master BMS controller triggers the activation and deactivation of the battery heating/cooling modes based on comparison of the battery temperatures with the low/high thresholds maintained by the master BMS, so that once the master BMS triggers activation of either battery heating mode or battery cooling mode, the batteries will reach the temperature at which the master BMS triggers deactivation of that mode before the batteries reach the set point temperature. Thus, the set point temperature, in these embodiments, is provided to accommodate the TMS controller's expectation of a set point, as discussed above with regard to system operation when the vehicle is active, rather than to control activation or deactivation of the battery heating/cooling modes when the vehicle is inactive. In other embodiments, the programming that controls the TMS controller's operation omits the need for the set point in battery heating/cooling modes when the vehicle is inactive, and the master BMS does not provide a set point to the TMS controller when activating those modes. Because, in such embodiments, the TMS controller may not monitor the battery coolant temperature in the battery heating/coolant modes, the lookup table may also be omitted. In still further embodiments, the TMS controller exits heating mode or cooling mode based on comparison of temperature of coolant in loop 122 with the set point temperature, as translated by the lookup table.

At 196, in response to a temperature correction signal 194 and the confirmation at 192 that the battery contactors are closed, and if the request at 194 is for battery heating, VCU 92 sends signals to pump 88 to actuate and, after pump 88 is confirmed to have started, heater 54 (FIG. 5), thereby actuating the first cooling fluid loop, which includes branch 106 (FIGS. 5 and 6). If the request at 194 is for either battery heating or battery cooling, VCU 92 sends a signal to pump 124 to actuate pump 124, thereby actuating second cooling fluid loop 122 (FIG. 5). Also at 196, and referring also to FIGS. 5 and 6, if the request at 194 is for battery heating, TMS controller 93 opens valves to allow coolant in coolant branch 106 of the first (heating) loop to flow to heat exchanger 114 but does not open the valves to allow coolant in coolant branch 106 to flow to the passenger heat exchanger and does not actuate the fan(s) that move air over the passenger heat exchanger and into the passenger cabin. Thus, as described above, coolant branch 106 contributes heat to the battery coolant in cooling fluid loop 122 which, in turn, moves the heated coolant through the plates upon which the high-voltage batteries are disposed, thereby warming the batteries. If the request at 194 is for battery cooling, TMS controller 93 opens valves (including the bypass expansion valve that allows refrigerant to flow to evaporator 128) to allow refrigerant flow throughout the third cooling fluid loop 132 as described above and actuates the refrigerant compressor, thereby moving the refrigerant through the loop. The TMS controller does not open the expansion valve to allow refrigerant in refrigerant loop 132 to flow to the main evaporator and does not actuate the fan(s) that move air over the main evaporator and into the passenger cabin. As described above, battery coolant in coolant loop 122 contributes heat to the refrigerant in loop 132 at evaporator 128. Loop 122 moves the cooled battery coolant through the plates upon which the high-voltage batteries are disposed, thereby cooling the high-voltage batteries. Since the electric vehicle is inactive, the TMS will not be in passenger heating mode or passenger cooling mode, as described above, when the master BMS notifies the TMS controller of the need for battery heating or cooling in the monitoring mode. Thus, the TMS controller does not need to accommodate those modes simultaneously with operation of the battery heating or cooling modes. Otherwise, operation of the TMS and the VCU in battery heating/cooling mode in the monitoring mode is similar to the battery heating/cooling modes operative when the vehicle is active.

When the master BMS controller detects the occurrence of an isolation fault from one or more of the battery pack BMUs that is 500 Ω/V or less, the master BMS controller puts a public message onto CAN bus 61 (FIG. 3) indicating the detection of the isolation fault, the severity of the fault (e.g. non-critical at 500 Ω/V or less but above 100 Ω/V or critical at 100 Ω/V or less), and the Ω/V level of that fault. If the master BMS instructed the VCU to activate the relevant vehicle controllers at 180a and 180b because, at 218, the master BMS controller detected the occurrence of an isolation fault from one or more of the BMUs that was 500 Ohms/V or less, then the VCU, in response to its programming, will receive that message from the master BMS controller on the CAN bus. In response, and referring also to FIG. 3, VCU 92 retrieves information from memory 136 that identifies electric vehicle 20 (FIG. 2) from among all electric vehicles (or, in some embodiments, all vehicles, regardless of energy source) managed by fleet operator 144 and sends an instruction to remote communications controller 116 over CAN bus 61 to transmit a signal to fleet operator 144 that includes the vehicle identification information, notice of the isolation fault, and whether the detected fault is critical or non-critical. In one or more embodiments, the VCU also instructs controller 116 to include the reported magnitude (e.g., Ω/V level) of the detected fault. In one or more embodiments in which the electric vehicle has a GPS system, VCU 92 instructs remote communications controller 116 to acquire the electric vehicle's location from GPS navigation unit 134, as discussed above, and to include the electric vehicle's location in the information transmitted to fleet operator 144. In that event, the remote communications controller communicates with GPS navigation unit 134, as described above and acquires the electric vehicle's location therefrom. Having received the VCU's instruction and acquired the electric vehicle's location information from the GPS navigation unit, remote communications controller 116 controls transmitter/receiver 130 to transmit a signal to fleet operator 144 via wireless network 142 that includes notice of the isolation fault, the electric vehicle's identification, the non-criticality or criticality of the fault (and/or the fault's Ω/V level), and, if GPS is utilized in the electric vehicle, the electric vehicle's GPS location. Upon receiving such information, fleet operator 144 may take action to dispatch technical personnel to investigate the reported fault.

In addition to reporting the isolation fault to the fleet operator, VCU 92, in one or more embodiments, controls the vehicle's lighting system 220 to actuate the electric vehicle's interior driver and passenger cabin lights, thereby facilitating such investigation. Further, or instead, in one or more embodiments, the VCU controls the lighting system to actuate the vehicle's headlights to thereby facilitate the vehicle's identification by investigating personnel, e.g. upon entering a vehicle yard. Still further, or instead, in one or more embodiments, the VCU controls alarm 138 (which may be considered part of vehicle lighting system 220 to the extent it includes a warning lamp) to actuate an amber warning lamp and/or located on the vehicle dash, which may include the vehicle instrument cluster, and/or an audible alarm mounted on the vehicle body, for example at the vehicle dash.

If the VCU detects the message, described above, from the master BMS controller that an isolation fault exists, the VCU does not instruct the master BMS to close the high voltage battery pack contactors, regardless of the temperature state of those battery packs or the charge level of the house batteries. Further, in one or more embodiments, the VCU initiates a timer to a predetermined (included in the VCU's programming) period of time. At the timer's expiration, the VCU disables the monitoring mode signal to the master BMS at 160 and puts the computer system into sleep mode. The timer period may be, e.g., a time by which it is expected that service personnel will arrive to address the isolation fault.

Accordingly, if the master BMS has instructed the VCU to activate the relevant vehicle controllers at 180a and 180b because, at 172, the house battery is below its low state of charge threshold or because, at 170, one or more of the high-voltage battery pack temperatures was too high or because one or more of the high-voltage battery pack temperatures was too low, or because, at 218, an isolation fault exists, master BMS 152 awakens the VCU from its low-power mode, and the VCU controls the high-voltage electrical power system and/or the TMS, or messages the fleet operator, to remedy the out-of-bounds condition. Master BMS 152 repeatedly queries the equalizer controller for the house batteries' state of charge, and repeatedly queries the BMUs for the high-voltage battery pack temperature and isolation fault status, in the 174-180-182-184-168-170-172-174-218 loop, and continues to detect that triggering state of charge or battery temperature condition or isolation fault condition until the condition changes (although, in the case of isolation fault, the VCU will disable monitoring mode). As noted above, because the master BMS controller triggers deactivation of the battery heating/cooling modes based on comparison of battery temperature to the same threshold (with a hysteresis offset) upon which the controller relied to trigger the heating/cooling mode, and because that comparison triggers deactivation before comparison of battery coolant temperature to the set point provided at 194 would trigger deactivation, the system effectively deactivates the battery heating and cooling modes based on the comparison at 170 (and 172 and 218), rather than comparison to the set point. Upon such detection, the master BMS controller notifies the VCU, which initiates the awakened controllers to return to their low-power modes.

If, in the case of an out-of-range temperature or low house battery charge, prior to the change of state of the controlling hardwire line from the master BMS to the VCU back to low at 198, the driver has actuated the vehicle through actuation of the vehicle's ignition key or pushbutton system, VCU 92 brings the signal at 156 to high, deactivates the refrigerant system compressor, pump 88, heater 54, and pump 124 (if any thereof are active) and sends an instruction over the CAN bus to master BMS 152 to open the high-voltage battery contactors, and master BMS 152 sends instructions to the BMUs over the CAN bus at 202 to open the battery pack contactors. In response, the BMUs open the contactors, thereby ending house battery charging and power to the high-voltage components of the TMS, and confirm this action to the master BMS via respective CAN bus messages at 204. Upon receiving such messages from all of the BMUs, master BMS 152 confirms to the VCU that the contactors have been opened, via a CAN bus message, at 206. VCU 92 then, at 208, changes the state of the hardwire signal to master BMS 152 that defines the master BMS's active/sleep state (i.e. the same hardwire signal as at 156/164/182) from high to low but also changes the state of signal 160 so that monitoring mode is turned off. Master BMS controller 152 correspondingly changes, at 210, the state of its hardwire connection to the BMUs that control the BMU's active/sleep state from high to low, causing the BMUs to return to a low power mode. The VCU correspondingly removes ignition power to the other vehicle controllers that the VCU controller controls into and out of sleep mode. Because monitoring mode is disabled, master BMS 152 does not restart the countdown of the one-hour clock before transitioning to low-power mode. The signal to the VCU caused by the operator keying the bus to the on condition then triggers the VCU to bring the system controllers out of sleep mode, as discussed above. If the driver keys on the vehicle when the signal at 180a/180b is low, the VCU brings the signal at 156 high, changes the state of signal 160 so that monitoring mode is turned off, and then brings the system controllers out of sleep mode.

A computer system that comprises the controllers discussed herein may be located entirely on the bus as shown in FIG. 2, or other electric vehicle, but may also comprise, at least partially, a server at a location remote from the bus and accessed by the bus computer system components via a wide area network such as the Internet. The computer system is generally a computing device capable of effecting the communications and functions as described herein. Where the computer system comprises a server accessible over a local area network or at a locationally remote data center accessible over a wide area network such as the Internet, the computer system may be considered to include a workstation, mobile computer, or other device through which such access is effected. In general, it should be understood that a single computer system need not execute all the computer-related steps discussed with respect to FIG. 7 and/or otherwise disclosed herein and that multiple computer systems can be utilized. A database may be a part of the computer system or may be accessible by the computer system over a local or wide area network.

One or more of the methods as discussed herein is embodied in or performed by one or more execution modules operating on the computer system, e.g., on one or more controllers thereof. An execution module may be a self-contained software system with embedded logic, decision making, state-based operations and other functions that may operate in conjunction with collaborative applications, such as web browser applications, software applications, and other applications that can be used to communicate with an operator, and in the illustrated embodiments comprises computer-executable instructions stored on a computer-readable medium, for example, embodied by a processor or controller such as a microprocessor or a programmable logic controller (PLC) or other suitable controller. A controller may comprise a discrete hardware device comprised of processing circuitry on which is programmed one or more software programs. Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, a tangible storage medium such as a random access memory (RAM), a read-only memory (ROM), an erasable programmable read-only memory (EPROM or flash memory), a non-volatile memory supporting a PLC, memory incorporated into a processor, or other optical or magnetic storage devices. Such a computer program typically is comprised of a multitude of instructions that may be translated by a computer, such as a controller, into a machine-readable format and hence executable instructions. The computer stores the execution module on a file system or memory, accesses the execution module from the file system and runs the execution module on a controller that is part of the computer system. Thus, the processing circuitry of the controller, or of a plurality of controllers comprising the computer system, is configured, under control of the program instructions of the computer software or firmware, to perform functions, e.g., functions as disclosed herein.

The execution module may include various submodules to perform the steps discussed herein, including a submodule that interfaces with other computer systems to thereby allow the operator to upload and/or download information. The interface module also allows the computer system to query and receive data from the database and distribute received data to one or more other submodules in the execution module, as appropriate, for further processing.

The execution module may also include graphical user interfaces (“GUIs”). The execution module may present, for instance, one or more predetermined GUIs to permit a user to input/select data into the system, direct the computer system to perform various functions, define preferences associated with a query, or input other information and/or settings. GUIs may be predetermined and/or presented in response to attempts by the vehicle operator to perform operations, execute queries, enter information and/or settings, operate functions of other modules, or communicate with other computer systems. The computer system generates the predetermined GUIs and presents them to the operator on a display of the computer system.

Based on the foregoing, it will be appreciated that embodiments of the disclosure provide improved systems and methods for maintaining vehicle battery systems in operative condition. Many modifications and other embodiments of the disclosure set forth herein will come to mind to one skilled in the art to which the disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed is:

1. An electric vehicle, comprising:
a body supported by a plurality of wheels;
at least one electric motor disposed so that the at least one electric motor drives the plurality of wheels;
at least one battery pack in selective electrical communication with the at least one electric motor;
a battery management system configured to output a first signal that includes information identifying whether the at least one battery pack has an electrical isolation fault;
a transmitter; and
a computer system that is in operative communication with the battery management system and the transmitter and that is configured to execute program instructions when the electric vehicle is in an inactive state, so that, upon detection that the first signal indicates that the at least one battery pack has an electrical isolation fault, the computer system transmits a second signal to a remote party through the transmitter that includes information corresponding to the existence of the electrical isolation fault indicated by the first signal.

2. The electric vehicle as in claim 1, wherein the transmitter is a wireless transmitter, and wherein the computer system is configured to execute program instructions so that the computer system transmits the second signal to the remote party through the wireless transmitter.

3. The electric vehicle as in claim 2, further comprising a light system disposed on the body, wherein the computer system is configured to execute the program instructions when the electric vehicle is in the inactive state so that, upon the detection that the first signal indicates that the at least one battery pack has an electrical isolation fault, the computer system controls at least one light in the light system to actuate.

4. The electric vehicle as in claim 3, wherein the at least one light is located on an instrument panel of the electric vehicle.

5. The electric vehicle as in claim 3, wherein the at least one light is an interior light in a passenger compartment of the electric vehicle.

6. The electric vehicle as in claim 3, wherein the at least one light is a headlight of the electric vehicle.

7. The electric vehicle as in claim 2, comprising an audible alarm disposed on the body, wherein the computer system is configured to execute the program instructions when the electric vehicle is in the inactive state so that, upon the detection that the first signal indicates that the at least one battery pack has an electrical isolation fault, the computer system controls the audible alarm to actuate.

8. The electric vehicle as in claim 2, wherein the computer system is configured to execute the program instructions when the electric vehicle is in the inactive state so that, upon the detection that the first signal indicates that the at least one battery pack has an electrical isolation fault and detection that the first signal indicates that a magnitude of the electrical isolation fault exceeds a predetermined level, the computer system initiates a predetermined response.

9. The electric vehicle as in claim 8, comprising an audible alarm disposed on the body, wherein the predetermined response is control of the audible alarm to actuate.

10. The electric vehicle as in claim 2, wherein the computer system, under control of the program instructions,
is configured, in a low-power mode in which the computer system deactivates the battery management system, to intermittently activate the battery management system and monitor the first signal, and
is configured to execute the program instructions so that, upon the detection that the first signal indicates that the at least one battery pack has an electrical isolation fault, the computer system exits the low-power mode.

11. The electric vehicle as in claim 1, comprising a propulsion system mounted on the body in operative communication with the plurality of wheels, wherein the propulsion system is disabled in the inactive state of the electric vehicle, and wherein the computer system, under control of the program instructions, is configured to exit the low-power mode, upon the detection that the first signal indicates that the at least one battery pack has an isolation fault, without actuating the propulsion system.

12. A method of managing operation of an electric vehicle, comprising the steps of:
providing
a body supported by a plurality of wheels,
at least one electric motor disposed so that the at least one electric motor drives the plurality of wheels,
at least one battery pack in selective electrical communication with the at least one electric motor,
a battery management system configured to output a first signal that includes information identifying whether the at least one battery pack has an electrical isolation fault, and
a transmitter; and
while the electric vehicle is in an inactive state, upon detection that the first signal indicates that the at least one battery pack has an electrical isolation fault, transmitting a second signal to a remote party through the transmitter that includes information corresponding to the existence of the electrical isolation fault indicated by the first signal.

13. The method as in claim 12, wherein, at the providing step, the transmitter is a wireless transmitter, and wherein the transmitting step comprises transmitting the second signal to the remote party through the wireless transmitter.

14. The method as in claim 12, comprising the steps of
when the battery management system is deactivated in the inactive state of the electric vehicle, intermittently activating the battery management system and monitoring the first signal, and
upon the detection that the first signal indicates that the at least one battery pack has an electrical isolation fault, exiting the inactive state.

15. The method as in claim 14, wherein the providing step comprises providing a propulsion system mounted on the body in operative communication with the plurality of wheels, wherein the propulsion system is disabled in the inactive state of the electric vehicle, and wherein the step of exiting the inactive state maintains the propulsion system disabled.

16. A method of managing operation of an electric vehicle, comprising the steps of:
providing
a body supported by a plurality of wheels,
at least one electric motor disposed so that the at least one electric motor drives the plurality of wheels,
at least one battery pack in selective electrical communication with the at least one electric motor,
a battery management system configured to output a first signal that includes information identifying whether the at least one battery pack has an electrical isolation fault, and
while the electric vehicle is in an inactive state,
deactivating the battery management system;
intermittently activating the battery management system to monitor the first signal; and
upon detection that the first signal indicates that the at least one battery pack has an electrical isolation fault, exiting the inactive state.

17. The method as in claim 16, further comprising, while the electric vehicle is in an inactive state, transmitting a second signal to a remote party through a transmitter, wherein the second signal includes information corresponding to the existence of the electrical isolation fault indicated by the first signal.

18. The method as in claim 16, further comprising providing a propulsion system mounted on the body in operative communication with the plurality of wheels, wherein the propulsion system is disabled in the inactive state of the electric vehicle, and wherein the step of exiting the inactive state maintains the propulsion system disabled.

19. The method of claim 16, wherein, if the first signal indicates that the at least one battery pack has an electrical isolation fault, determining the magnitude of the isolation fault in units of ohms per volt (Ω/V).

20. The method of claim 19, wherein the determination of the magnitude of the isolation fault is made by the battery management system.
